(19) United States
(12) Patent Application Publication
(10) Pub. No.: US 2022/0096964 A1
(43) Pub. Date: Mar. 31, 2022

(54) MEMBRANE, MEMBRANE CONTACTOR, APPARATUS AND METHOD FOR REMOVAL OF DISSOLVED OXYGEN FROM FLUID

(71) Applicant: NGEE ANN POLYTECHNIC, Singapore (SG)

(72) Inventors: Jincai SU, Singapore (SG); Yanyan WEI, Singapore (SG)

(73) Assignee: NGEE ANN POLYTECHNIC, Singapore (SG)

(21) Appl. No.: 17/425,575

(22) PCT Filed: Jan. 22, 2020
(86) PCT No.: PCT/SG2020/050034

§ 371 Date: Jul. 23, 2021

(30) Foreign Application Priority Data
Jan. 25, 2019 (SG) 10201900683W

(51) Int. Cl. B01D 19/00; B01D 69/08; B01D 69/02; B01D 71/34; B01D 67/00; B01D 61/58; C02F 1/20; C02F 3/30; C02F 1/44; B01D 65/02; A01K 63/04

(52) U.S. Cl. CPC B01D 19/0031; B01D 69/082; B01D 69/02; B01D 71/34; B01D 67/0016; B01D 61/58; C02F 2103/20; C02F 3/305; C02F 1/44; B01D 65/02; A01K 63/045; B01D 2325/38; B01D 2325/02; C02F 1/20

(57) ABSTRACT

A hollow fiber membrane for removal of dissolved oxygen from fluid that is made of a porous hydrophobic material and an apparatus for controlling nitrate concentration level in water comprising a membrane contactor having the membrane, the membrane comprises at least one tubular fiber comprising: an outer wall for contacting fluid external to the tubular fiber; at least three inner channel walls for contacting fluid internal of the tubular fiber, wherein each inner channel wall forms a fluid communicating channel; a plurality of pores, wherein pores proximate to surfaces of the outer wall and each inner channel wall are smaller in size than pores non-proximate to said surfaces of the outer wall and each inner channel wall, wherein a central portion of the tubular fiber has a thickness greater than thickness of the tubular fiber outside the central portion.

### FIELD OF THE INVENTION

This invention relates to a membrane, a membrane contactor and, in particular, a method of using such membrane contactor for degassing of fluids.

The invention further relates to the use of the membrane contactors in an apparatus and a corresponding method for selective removal of dissolved oxygen for the development of a membrane-based denitrification system for a recirculating aquaculture system.

### BACKGROUND

Dissolved oxygen (DO) needs to be carefully controlled in many production areas such as pharmaceuticals, food, power, biotechnology and semiconductors. In semiconductor industry, for instance, the presence of DO in ultrapure water, even at ppb level, facilitates the uncontrolled formation of silicon dioxide films and defects on wafers. In the power industry, DO distinctly accelerates metal corrosion in the boiler or steel pipes. DO in pharmaceutical and food production processes not only causes the corrosion of equipment but also favors the growth of bacteria, which deteriorate the lifetime of the products. Consequently, removal of DO from water is an important step for protecting the equipment from corrosion in power industry or enhancing the product quality in pharmaceutical, food and semiconductor industries.

Conventional methods for deoxygenation include vacuum tower, forced draft degasifies, steam deaerators and chemical reagents. Thermal and vacuum degassing are the most conventional physical methods and they have inherent drawbacks of high operating costs and bulky constructions. Chemical approaches scavenge DO by the addition of reducing agents such as hydrazine or sodium sulfite. The reaction of reducing agents and DO generates solid products that are contaminants, and it brings environmental and safety hazards due to storing and handling chemicals. Hybrid systems combining both the physical and chemical approaches have also been developed and used for DO control.

The interest in deoxygenation through hollow fiber membranes contactor has been steadily increasing during the past decade due to their high efficiency as well as energy, space and cost savings. In a membrane contactor, separation of oxygen/water is typically accomplished through the membrane based on the concentration gradient of oxygen in water phase and in the gas phase with the gas phase under vacuum or sweeping with high purity nitrogen.

Hollow fiber membranes for deoxygenation are preferentially made of polypropylene (PP), polyvinylidene fluoride (PVDF) and polytetrafluoroethylene (PTFE). Being hydrophobic, these membranes do not allow liquid water to pass through in case the pressure of the feed water is below the breakthrough pressure, i.e., Liquid Entry Pressure (LEP), which could be correlated with the membrane structure via the Cantor-Laplace equation:

$$L E P = \frac{- 2 γ cos θ}{{r}_{max}} \qquad ( 1 )$$

where γ is the surface tension of the wetting liquid (in this case water at 25° C., 0.07199 N·m⁻¹), θ is the contact angle between the membrane and the wetting liquid (water), and rₘₐₓ is the maximum radius of the membrane pores.

In hollow fiber membrane modules for deoxygenation, liquid water flows in the lumen or shell side while the other side is under vacuum. To enhance the efficiency, vacuum plus sweeping with high purity nitrogen gas could be used. The transport of oxygen through hydrophobic membrane is illustrated in FIG. 1, where C_{b} refers to the DO concentration in the liquid; Cᵢ refers to the DO concentration at the liquid-membrane interface; Pₘ refers to the pressure of oxygen at the membrane surface of permeate side; P_{b} refers to the pressure of oxygen at the bulk of permeate side; kₗ refers to the mass transfer coefficient at the liquid phase; kₘ refers to the mass transfer coefficient within the membrane and k_{g} refers to the mass transfer coefficient at the gas phase.

The overall resistance to the transport of oxygen could be expressed using the resistance-in-series concept:

$$\frac{1}{K} = \frac{1}{{k}_{l}} + \frac{{RTd}_{i}}{H {k}_{m} {d}_{m}} + \frac{{d}_{i}}{H {k}_{g} {d}_{o}} \qquad ( 2 )$$

where K, kₗ, kₘ and k_{g} are the overall mass transfer coefficient and individual mass transfer coefficients at the liquid phase, membrane and gas phase, respectively; dᵢ, dₘ and dₒ are inner, logarithmic mean and outer diameters of the hollow fiber, respectively. At the side under vacuum, the resistance is negligible and the element dᵢ/(Hk_{g}dₒ) can be ignored. When water flows in the lumen side of hollow fibers, the flow rate of water influences the mass transfer coefficient and kₗ might dominate K. This is supported by pilot-scale testings. Water vapor permeation in vacuum deoxygenation has been found to enhance the mass transfer of oxygen across the membrane, thus favoring the removal of oxygen.

Commercial PP membranes assisted by nitrogen sweeping have been used for DO removal from deionized (DI) water. For the membrane contactors with areas below 0.1 m², the exiting DO concentration achieved was in the range of 0.3-0.8 ppm. At a water flow rate of 30 mL min⁻¹, the exiting DO concentration could be reduced to below 1 ppm with a membrane area of 0.1 m² and 8 ppb with a membrane area of 0.4 m². PP hollow fiber membranes have also been used to make pilot-scale membrane contactors and tested for deoxygenation performance. The transverse flow of water at the shell side favored good performance. The membrane contactors were integrated with reverse osmosis (RO) system for water production and very stable DO removal efficiency was observed during the half-year test. Commercial PP membrane contactors have also been used in the end-shield cooling system of a Nuclear Power Plant for corrosion control by removing DO. The DO removal efficiency observed was at 87-98% and it could be further enhanced with better vacuum, lower water flow rate and higher water temperature.

PP hollow fiber membranes have been used for boiler feed water deoxygenation via vacuum degassing process. Membrane fouling occurred and the foulants were mainly organic matter and aluminum silicate.

Membrane contactors equipped with polyethylene and poly methyl pentene hollow fiber membranes have also been used for water deoxygenation.

Other than PP membranes, a transverse flow membrane contactor made with hydrophilic polysulfone hollow fiber membranes (X-Flow) have been used to remove 99.6% of the oxygen from water with nitrogen gas sweeping. The exiting DO concentration was found to be below 0.04 ppm and the mass transfer coefficient observed was three orders of magnitude lower than that for hydrophobic PP membranes.

To achieve large surface area, the majority of membranes used in membrane contactors are single-bore hollow fiber membranes (i.e. slim fibers) with outer diameter in the range of 300-600 μm. A high packing density is preferred. To be used for degassing in a Reverse Osmosis (RO) system or ultrapure water, the membrane contactors have shown excellent performance as discussed above. However, they are not applicable or practical to be used in all applications.

For instance, for water streams containing foulants such as those obtained from recirculating aquaculture systems (RAS), frequent air scouring and chemical cleaning are unavoidable. It is quite common that slim fibers break and entangle one another during washing, shaking or mechanical cleaning. Fiber breakage would cause entry of liquid water into the vacuum system in such RAS, thus spoiling the deoxygenation operation. RAS is a type of closed containment aquaculture system for fish culture in controlled indoor environment. Due to limited space, manual labour and water resources in Singapore, local fish farmers are very keen to adopt RAS. However, accumulation of nitrogenous wastes (ammonia, nitrate and nitrate) is a serious problem in RAS. The nitrogenous wastes are produced when bacteria or fungi breakdown redundant high protein-containing feed and also from the biological wastes excreted by the cultivated species (e.g. fishes or shrimps).

These nitrogenous wastes, especially ammonia, are either toxic to the fish and shrimp or would inhibit their growth if present in the RAS. If discharged, these high levels of nitrate would cause eutrophication and harmful algae blooms in the waterways that would have a disastrous effect on the ecosystem.

There is growing interest in RAS in recent years due to the worsening pollution of the sea, lakes and rivers and the expectation on more intensified production to feed the growing population. RAS enables minimum water consumption, offers improved control of culture conditions, and allows accurate quantification of culturing conditions and their effects on physiological rates such as aeration, feeding, fresh water, and waste accumulation and disposal. RAS makes it possible to place the farms in locations where water resources are limited and offers the flexibility of switching the culturing species to follow the market demand or preference for seafood products. Nevertheless, the accumulation of nitrate in RAS facilities as the end product of nitrification affects the growth of culturing species and it is more serious in the systems where nitrifying biofilters are used. High level of nitrate in the culturing system causes fishes to lose appetite, become listless and even die though the toxicity of nitrate to fish is far less than that of ammonia. Water consumption and environmental impact are also driving forces for nitrate control in RAS.

To control the nitrate level in RAS, two methods have been commonly practiced. One method is to exchange a fraction of water in the culturing system each day with water low in nitrate. Easy to be implemented, water replacement is being used in many RAS facilities. Except for the consumption of a large quantity of water, the same amount of wastewater containing dissolved solids and dissolved nutrients is discharged everyday. Discharge of nitrate into receiving water courses would adversely affect the existing aqueous ecosystems and incur unexpected situations such as algal booming. Although water exchange is a simple way to control nitrate levels in the culturing system, it creates detrimental effects on the environment upon discharge of nitrogen in any form, increased water usage and additional energy when the exchange water requires heating or cooling. In a small country like Singapore, water exchange is not a preferred solution.

Another method is to convert nitrate through a biological process named as denitrification, which reduces nitrate to nitrogen gas by using nitrifying bacteria. Denitrification depends on nitrifying bacteria (also known as facultative heterotrophic bacteria or facultative bacteria) which reduces nitrate NO₃⁻ to nitrite (NO₂⁻), nitric oxide (NO) and nitrous oxide (N₂O), before eventually converted to N₂. Denitrifying bacteria requires anaerobic condition (low level of DO) and thus the denitrification system is costly to build and challenging to operate. Though relatively expensive compared with water replacement, biological denitrification attracts more attention recently because it offers high rate of nitrate removal and minimizes the discharge of wastewater and consumption of new water. Constructed wetland, algal pond, and aquaponics have also been used for nitrate removal but they are mainly for other culturing systems.

Facultative bacteria need a carbon source as food to live while facultative bacteria get their oxygen by taking DO from water or taking it off nitrate molecules. If both DO and nitrate are present, facultative bacteria tend to prefer oxygen. It is commonly perceived that DO acts as an inhibitory and toxic agent to anaerobic treatment because the invasion of oxygen influences the activity of denitrifying bacteria. The optimum DO level for simultaneous nitrification and denitrification was 0.5-1.0 ppm and the total nitrogen removal efficiency has been observed at 70.6%. The nitrogen removal efficiency was compromised when the DO concentration was beyond 1.0 ppm. It has been shown that denitrification could occur at the DO level of 3-5 ppm, but the increase in DO levels could cause severe drop of the denitrification performance and the consumption rate of the carbon source was increased. The denitrification rate has been shown to drop from 5.5 to 0.5 NO₃—N L⁻¹d⁻¹ when the DO level increased from 0.5 to 4.0 ppm. A denitrification efficiency of 50% has been observed at DO levels higher than 4 ppm. Therefore, anaerobic environment with proper DO control is essential to the efficiency and stability of denitrification.

It is hard to completely avoid the invasion of oxygen into the anaerobic denitrification system because most reactors are operated within an aerobic open environment. However, proper control of DO level favors the denitrification process and is thus preferable. Oxygen scavenging agents such as sodium sulfite and iron sulfide are known to be effective to deplete DO from anaerobic bioreactors. However, the reaction of reducing agents and DO generates solid products that are contaminants, and this results in environmental and safety hazards due to storing and handling chemicals. More seriously, the reducing agents and the products of reduction reaction would have adverse influences on the aquatic species.

As described above, membrane contactors packed with slim HF have been developed and used for effective control of DO level in semiconductor ultrapure water. However, no suitable membrane contactors are available for anaerobic denitrification systems which contains various foulants. Dual-layer membrane formation using different polymers may be considered. However, it is not a viable option as the fabrication of such dual-layer membrane may not be scalable.

Many patents on nitrogen removal from wastewater have been granted. The typical process for nitrogen removal is the biological nitrification and subsequent denitrification. For example, U.S. Pat. No. 5,536,407A demonstrated a nitrification-denitrification process carried out in three separated basins for the treatment, where 65% nitrate conversion could be achieved. In recent years, with the success in membrane fabrication, new processes based on membrane bioreactors have been developed for wastewater treatment. For example, patents US20130247832A1, CN104341040A and CN101302059A presented the membrane film bioreactor for denitrification and the nitrogen removal efficiency could be more than 90% within 8 hours. Although fairly successful in wastewater treatment, these processes are difficult to be adopted by fish farmers due to the large footprint, high energy consumption, high operating cost, and stringent process conditions.

### SUMMARY

According to examples of the present disclosure, there are provided a hollow fiber membrane, a membrane contactor comprising the hollow fiber membrane, and an apparatus for controlling nitrate concentration level in water contained in a recirculating aquaculture system as claimed in the claims. Some optional features other than the aforementioned features are also defined in the claims.

### BRIEF DESCRIPTION OF THE DRAWINGS

Embodiments of the invention will be better understood and readily apparent to one skilled in the art from the following written description, by way of example only and in conjunction with the drawings, in which:

FIG. 1 illustrates the transport of oxygen through a hydrophobic membrane.

FIG. 2 is a schematic diagram of a tri-needle spinneret.

FIG. 3 is a schematic diagram of the deoxygenation system.

FIG. 4 is a series of SEM images of tri-bore PVDF hollow fiber membrane TBF-3.

FIG. 5 is a series of SEM images of tri-bore HF membranes under different spinning conditions.

FIG. 6 illustrates the XRD patterns of tri-bore hollow fiber membrane TBF-3.

FIG. 7A is a two-dimensional AFM image of the inner surface of the TBF-3 membrane.

FIG. 7B is three-dimensional AFM image of the inner surface of the TBF-3 membrane.

FIG. 8 is a graph illustrating the effect of the water flow rate on the deoxygenation performance of TBF-3 at the circulation mode.

FIG. 9A is a graph (Remaining DO vs. time) illustrating the effect of the water flow rate on the deoxygenation performance of TBF-3 at the one-pass mode.

FIG. 9B is a graph (Experimental mass transfer coefficient and DO removal efficiency) illustrating the effect of the water flow rate on the deoxygenation performance of TBF-3 at the one-pass mode.

FIG. 10 is a graph illustrating the deoxygenation performance of the TBF-3 membrane at different temperatures.

FIG. 11 is a graph illustrating the effect of operating temperature on the mass transfer through the TBF-3 membrane.

FIG. 12 is a graph illustrating the effect of the water flow rate on the mass transfer of the TBF-3 membrane.

FIG. 13 is a graph illustrating the effect of the vacuum on the mass transfer of the TBF-3 membrane.

FIG. 14 illustrates membrane modules (a), top view of the module (b), cross section of the tri-bore hollow fiber (c) and its inner surface (d) and outer surface (e).

FIG. 15 is a schematic diagram of the deoxygenation system.

FIG. 16 is a graph illustrating the effect of the water flow rate on the oxygen removal efficiency.

FIG. 17 is a graph illustrating the resistance to oxygen transport at different water flow rates.

FIG. 18 is a graph illustrating the effect of vacuum on the deoxygenation efficiency.

FIG. 19A illustrates the membrane module before and after the deoxygenation experiment.

FIG. 19B is a graph illustrating the exiting temperature of water.

FIG. 20A is a graph illustrating the radial concentration profiles at different vacuum levels (11, 20 and 29 inHg) and water flow rates (300 and 900 mL min⁻¹).

FIG. 20B is a graph illustrating the axial concentration profiles at different vacuum levels (11, 20 and 29 inHg) and water flow rates (300 and 900 mL min⁻¹).

FIG. 21 is a schematic of the concentration profile of oxygen at different phases.

FIG. 22 illustrates the morphology of tri-bore HF membrane.

FIG. 23 is the pore size distribution curve of the tri-bore hollow fiber membrane.

FIG. 24 illustrates the deoxygenation performance of tri-bore HF membranes in series and parallel.

FIG. 25 illustrates the deoxygenation of unfiltered aquaculture water at different flow rates.

FIG. 26 illustrates the deoxygenation of unfiltered aquaculture water.

FIG. 27 illustrates the deoxygenation of filtered aquaculture water.

FIG. 28 illustrates the performance of tri-bore HF membranes in terms of (a) effectiveness of cleaning and (b) efficiency of deoxygenation.

FIG. 29 illustrates the theoretical mass transfer coefficient at different flow rates.

FIG. 30 illustrates the concentration of DO in radial direction for different axial points.

FIG. 31 illustrates the concentration of DO in axial direction for differential radial points.

FIG. 32 illustrates the molar flux of DO at different water flow rates.

FIG. 33 is a schematic diagram of the denitrification system.

FIG. 34 is a comparison diagram of the current method and the denitrification system described herein.

These figures are not drawn to scale and are intended merely for illustrative purposes.

### DETAILED DESCRIPTION

An example of the present disclosure discloses a new and simple method for efficient nitrate control in Recirculating aquaculture system (RAS). The example is a simple, efficient and low-cost method for denitrification suitable for small and medium RAS. The method does not incur large investment cost and is very easy to implement. Lab-scale tests showed very promising results. Details of this example will be discussed in later parts of the present disclosure.

It has been observed by the inventors of the present invention that to date, there are no multibore hollow fiber (HF) membranes particularly designed for deoxygenation applications. One of the objectives of the present disclosure is to develop such multibore HF membranes. In an example of the present disclosure, tri-bore HF membranes are proposed. These tri-bore HF membranes have enhanced mechanical strength and capability for the removal of DO from water. The effects of operating conditions on the DO removal efficiency of these tri-bore HF membranes have been studied and the mass transfer coefficient of deoxygenation has been determined. One application of such multibore HF membranes can be used in a method for efficient nitrate control in RAS.

In a study involving the tri-bore HF membranes, these membranes have been prepared for the removal of DO from water. The morphology of the membranes is studied. Two membrane modules are fabricated, each containing 200 pieces of hollow fibers, each fiber with an effective length of 24 cm. Each fiber is elongate and tubular in shape. Deoxygenation experiments are carried out by connecting the two membrane modules in series and continuously flowing normal city water in the fiber lumen side and applying vacuum in the shell side.

The concentration of DO before and after the membrane modules is monitored. The effects of vacuum level and water flow rate on the oxygen separation efficiency are examined. Mathematical modeling is conducted to determine the individual mass transfer coefficients at the liquid phase and across the membrane as well as the overall mass transfer coefficient. The concentration profiles of DO along radial and axial directions in the membrane lumen side are also calculated. The influences of water flow rate and vacuum level on the concentration profiles have been investigated. The study not only discloses the potential of the newly developed tri-bore hollow fiber membranes for water degassing applications but also provides valuable analysis on the mass transfer in the deoxygenation process.

The fabricated hollow fibers are characterized in terms of morphology, porosity, hydrophobicity and mechanical strength. The performance of the fabricated membranes were evaluated for the deoxygenation of DI water and aquaculture water. Two membrane modules, each including 200 pieces of hollow fibers, are connected in series or parallel in order to determine the optimum operation mode. The deoxygenation test is firstly conducted for DI water and then for aquaculture water. Various methods including water flushing, air blowing or chemical cleaning have been applied to assure the cleaning efficiency after membrane fouling. A mathematical model has been developed by using the resistance-in-series concept by taking into account boundary layer and membrane characteristics. Overall mass transfer coefficient, radial and axial concentration profiles, and molar flux of oxygen at different water flow rates are calculated. With water flowing in the lumen side and vacuum in the shell side, the membrane performance was found to vary with water flow rate and vacuum level. The observations have provided solid evidence for the development of membrane-based denitrification system for RAS.

Specifically, in examples described as follows, Tri-bore hollow fiber membranes with a triangular outer geometry were fabricated from PVDF and explored for water deoxygenation. The representative membranes were hydrophobic and porous as seen from the contact angle of 94° and the porosity of 75%. The maximum load, elongation at break and the tensile stress of the tri-bore hollow fiber membranes were 3.90 N, 37.81% and 1.27 MPa, respectively, showing that prepared fibers were robust. The membranes were investigated for water deoxygenation, and mass transfer coefficients were found to be in the range of 1.89-7.40×10⁻⁵ m s⁻¹.

Increasing the water flow rate resulted in higher deoxygenation efficiency under a circulation mode was tested but it almost did not influence the performance at a one-pass mode. Details on circulation and single-pass modes will be provided later. Operating temperature was observed to influence the deoxygenation in the early stage of experimentation and its influence was negligible after 30 min. The developed tri-bore hollow fiber membranes showed the potential for liquid degassing applications. Theoretical analysis disclosed that the resistance to the transport of oxygen across the membrane was mainly at the liquid water side.

Development, Fabrication and Characterization of Membrane Contactor

Materials

Kynar HSV 900 PVDF supplied by Arkema Inc. was used for the fabrication of tri-bore hollow fiber membranes. N-methyl-2-pyrrolidone (NMP, 99.5%) and polyethylene glycol 400 (PEG400, >99.0%) used in membrane fabrication were supplied by Merck. DI water from Milli-Q (Millipore) system was used in all experiments.

Preparation of Tri-Bore Hollow Fiber Membranes

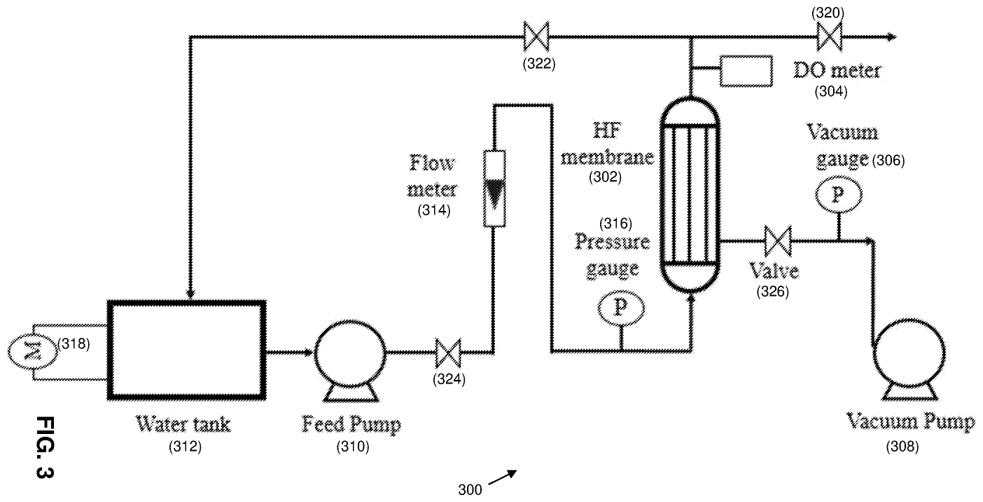

Tri-bore hollow fiber membranes were fabricated via a dry-jet wet phase inversion spinning process. With reference to a cross-sectional view in FIG. 2, a tri-bore spinneret 200 used for the spinning process has three needles (not shown), which are distributed uniformly within three spinneret spaces 202 as shown in FIG. 2.

The spinneret spaces 202 are each circular in the present example. A certain distance between channels represented by the three spinneret spaces 202 in FIG. 2 is employed to avoid potential intra-bore crossing of nascent fibers due to a dies well phenomena. For instance, distance between adjacent channels may be x mm, thickness of a channel wall to an outer surface of the spinneret 200 may be x mm, and diameter of each channel may be 2x mm. x is a predetermined value, which is determined based on the rheological properties of polymer solutions. For hollow fiber spinning, the dope solution and bore fluid were supplied at specified flow rates by ISCO syringe pumps (Teledyne, 1000D). After entering the coagulation bath, the nascent fibers precipitated and were collected by a take-up roller.

Detailed spinning conditions are summarized in Table 1 below. After spinning, the as-spun tri-bore hollow fiber membranes were immersed in tap water for 2 days to completely remove the residual solvent and additives. The fibers were then frozen in a refrigerator and dried overnight in a freeze drier (S61-Modulyo-D, Thermo Electron).

TABLE 1
Spinning conditions of TBF membranes

| Membrane ID | TBF-1 | TBF-2 | TBF-3 | TBF-4 | TBF-5 |
|---|---|---|---|---|---|
| Polymer concen- | 12 | 13 | 15 | 15 | 17 |
| tration (wt %) | | | | | |
| Additive | PEG400 + LiCl | PEG400 + LiCl | PEG400 | Nil | Nil |
| | (8 wt % + 2 wt %) | (5 wt % + 1 wt %) | (5 wt %) | | |
| Dope flow rate | 5 | 5 | 6 | 5 | 7 |
| (mL min−1) | | | | | |
| Bore fluid | NMP/water | NMP/water | NMP/water | Water | Water |
| | (50/50 wt %) | (20/80 wt %) | (20/80 wt %) | | |
| Bore flow rate | 2.5 | 3 | 1.25 | 3 | 2 |
| (mL min−1) | | | | | |
| External | Water | Water | NMP/water | Water | Water |
| coagulant | | | (30/70 wt %) | | |
| Air-gap (cm) | 1 | 1 | 15 | 10 | 10 |

| | |
|---|---|
| Take up speed | Free-fall |
| (m min−1) | |
| Temperature (oC) | 25 |
| Room | 65-75 |
| humidity (%) | |

Characterization of the Membranes

Membrane morphology was inspected using a Field Emission Scanning Electron Microscope (FESEM, JEOL JSM-7600F). For FESEM inspection, membrane samples were fractured cryogenically in liquid nitrogen and coated with platinum using a sputtering coater (JEOL JFC-1600).

The membrane surface topology was examined using a Bruker Dimension Icon Atomic Force Microscope (AFM). Small samples of the dried membranes (˜0.5 cm²) were glued on a metal substrate. An area of 5×5 μm² was scanned using the tapping mode. Various roughness parameters such as the mean roughness (Ra), root mean square Z values (Rms), and maximum vertical distance between the highest and lowest data points (Rmax) were used to quantify the surface topology of the membranes.

Powder X-ray diffraction (XRD) patterns were investigated using a Bruker AXS X-ray powder diffractometer (D8 Advance, Cu Kα, λ=0.154060 nm). The fiber mechanical properties including the maximum load, elongation at break and tensile stress were examined using an Instron tensiometer (Model 3366, Instron Corp.) at room temperature. The starting gauge length was 50 mm, and a constant elongation rate of 10 mm min⁻¹ was applied. For each spinning condition, five fiber samples were tested and the average values were reported.

Dynamic contact angle of the outer surface of the fibers was measured using a Data physics DCAT21 tensiometer. Five measurements were made and the results were averaged for report.

The membrane porosity, ε, is calculated from:

$$ɛ = ( 1 - \frac{{m}_{fibe r} / {ρ}_{fibe r}}{{V}_{fibe r} - {V}_{c h a n n e l}} ) \times 100 \qquad ( 3 )$$

where m_{fiber} is the mass of fiber, p_{fiber} is the density of the fiber material (1.78 g cm⁻³), V_{fiber} is the fiber volume calculated from the fiber outer diameter and fiber length, and V_{channel} is estimated from the fiber inner diameter and fiber length.

Description of Experiments Illustrating DO Removal Using DI Water

The deoxygenation performance of the bundled freeze-dried tri-bore hollow fiber membranes 302 made as described above was evaluated through a lab-scale degassing system 300 as shown in FIG. 3.

FIG. 3 shows the following.
(a) The bundled freeze-dried tri-bore HF membranes 302 fixed in membrane contactors.
(b) A DO meter downstream of the hollow fiber membranes 302 for measuring level of oxygen in fluid filtered by the hollow fiber membranes 302. The filtered fluid output from the hollow fiber membranes 302 is deoxygenated fluid.
(c) A valve 322 in a fluid line branched out from a junction downstream of the DO meter 304 for controlling deoxygenated fluid flow to a water tank 312.
(d) A valve 320 in a fluid line branched out from the junction downstream of the DO meter for controlling deoxygenated fluid to exit to another location that is not shown in FIG. 3.
(e) A valve 326 connecting shell side of the hollow fiber membranes to a vacuum pump 308. A vacuum gauge 306 is connected between the hollow fiber membranes and the vacuum pump 308.
(f) Upstream of the hollow fiber membranes 302 is a feed pump 310 for drawing fluid from the water tank 312 to pass into lumen side of the hollow fiber membranes 302. A circulator 318 is connected to the water tank 312 for controlling the temperature of the water in the water tank 312.
(g) A flow meter 314 and a pressure gauge 316 are placed in a fluid line between the feed pump 310 and the hollow fiber membranes 302.
(h) A valve 324 is placed between the flow meter 314 and feed pump 310.

In the present example, prior to the tests, the membrane contactors were prepared by bundling the fiber membranes 302 into Φ⅜ inch stainless steel tubing with the two ends sealed using epoxy resin. Every membrane contactor contained five pieces of fibers 302 with an effective length of 91 cm.

For the deoxygenation tests, DI water was pumped to the lumen side of the hollow fiber membranes 302 while vacuum was applied on the shell side. Two operation modes were tried, i.e., single-pass and circulation. In the single-pass experiments, water was discharged directly after passing through the membrane contactor. In the circulation trials, 500 mL water was used and it was returned back to the water tank after exiting from the membrane contactors. All the experiments were conducted at fixed temperatures controlled by using a water circulator (Julabo; not shown in FIG. 3), and DI water was used to avoid the possible influence of membrane fouling.

The efficiency (E) of deoxygenation is expressed as:

$$E = ( 1 - \frac{{C}_{out}^{l}}{{C}_{in}^{l}} ) \times 100 \% \qquad ( 4 )$$

where C^{l}ᵢₙ in and C^{l}ₒᵤₜ are the DO concentrations in water at the inlet and outlet of a membrane contactor, respectively.

For deoxygenation experiments at the circulation mode, the experimental mass transfer coefficient (kₑₓₚ) could be determined by:

$$ln [ \frac{{C}_{t} - {C}^{*}}{{C}_{0} - {C}^{*}} ] = \frac{Q}{V} [ exp ( - {k}_{e x p} a \frac{L}{ω} ) - 1 ] \qquad ( 5 )$$

Where C₀, C* and Cₜ are the initial DO concentration, the DO concentration that equilibrates with the gas phase within the membrane 302, and the remaining DO concentration at different experiment time, respectively, Q is the water flow rate measured by the flow meter 314, V is the volume of water in the tank 312, a is the membrane surface area to volume ratio, L is the length of the HF membranes, and w is the water velocity. The value of C* is estimated by using the Henry's law:

Pₘ=HC* (6)

Where Pₘ is the average pressure within the membrane pore. At the single-pass mode, the experimental mass transfer coefficient kₑₓₚ is defined as:

$${k}_{e x p} = \frac{Q ( {C}_{out}^{l} - {C}_{in}^{l} )}{{{A}_{m} ( Δ C )}_{l m}} \qquad ( 7 )$$

where Q is the water flow rate, Aₘ is the inner surface area of the hollow fiber membranes and (ΔC)ᵢₘ is the logarithmic mean concentration difference of DO. (ΔC)ᵢₘ is defined as:

$${( Δ C )}_{l m} = \frac{( {C}_{in}^{l} - {C}^{*} ) - ( {C}_{out}^{l} - {C}^{*} )}{ln [ ( {C}_{in}^{l} - {C}^{*} ) / ( {C}_{out}^{l} - {C}^{*} ) ]} \qquad ( 8 )$$

Theory Underpinning the DO Removal Using Hollow Fiber Membranes

The mass transfer in vacuum deoxygenation involves the diffusion of oxygen in liquid water, membrane pores, and surrounding vacuum or gas stream. The sum of the resistance defines the overall resistance to gas transfer within a membrane contactor, as shown in the equation below:

$$\frac{1}{{K}_{c a l}} = \frac{1}{{k}_{l}} + \frac{1}{H {k}_{m}} + \frac{1}{H {k}_{g}} \qquad ( 9 )$$

where kₗ, kₘ, and k_{g} are the mass transfer coefficients in the liquid water, across the membrane and in the gas film layer, respectively, and H is a Henry's law constant. Water always flows at the lumen side of the tri-bore HF membranes 302 in this study. Since the shell side is kept at vacuum, the resistance in the gas film layer is negligible.

Empirically, the mass transfer coefficient in the liquid water within the membrane contactor can be expressed using Sherwood, Reynolds and Schmidt numbers as below:

$$\begin{matrix}Sh = 1.85 {( ReSc \frac{{d}_{e}}{L} )}^{0.33} & ( 10 ) \\ Sh = {k}_{l} \frac{{d}_{e}}{D} & ( 11 ) \\ Re = \frac{{d}_{e} ωρ}{μ} & ( 12 ) \\ Sc = \frac{μ}{ρ D} & ( 13 )\end{matrix}$$

where dₑ is the equivalent diameter of the liquid water flow channel within the membrane contactor, p is viscosity, D is the diffusivity of oxygen within the liquid water and p is the density of water. Oxygen molecules passing thorough the porous PVDF tri-bore hollow fiber membranes 302 involve Knudsen diffusion or viscous flow, but the former may be dominant based on the fact that the pores of the membranes are around 100 nm. Knudsen number (Kₙ) is defined as the ratio of the mean free path (λ) of the oxygen molecule to the pore diameter of the membrane (dₚ):

$${K}_{n} = \frac{λ}{{d}_{p}} \qquad ( 14 )$$

The mean free path of oxygen molecules can be calculated by the following equation:

$$λ = \frac{{k}_{B} T}{\sqrt{2} {π P}_{m} {σ}_{w}^{2}} \qquad ( 15 )$$

where k_{B} is the Boltzmann constant and σ_{O2} is the collision diameter of oxygen. In the case of Kₙ>10 or dp<0.1λ, the collision between oxygen molecules and the pore wall is dominant over the collision between oxygen molecules. Therefore, the transport of oxygen molecules is mainly through Knudsen diffusion and the mass transfer coefficient across the membrane can be expressed as:

$${k}_{m , Kn} = \frac{2}{3} {( \frac{8 {M}_{w}}{π RT} )}^{0.5} \frac{{ɛ r}_{p}}{δτ} \qquad ( 16 )$$

where ε, rₚ, δ and τ are the porosity, pore radius, thickness and pore tortuosity of the membrane, respectively, M_{w} is the molecular weight of oxygen, R is the gas constant and T is the absolute temperature.

When Kₙ<0.01 or dₚ>100λ, the mean free path of oxygen molecules is negligible compared to the pore dimension and the collisions between oxygen molecules dominate. For this case, the viscous flow exists and the mass transfer coefficient across the membranes 302 can be determined by:

$${k}_{m , vis} = \frac{1}{8 η} \frac{{ɛ r}_{p}^{2}}{δτ} \frac{{M}_{w} {P}_{m}}{RT} \qquad ( 17 )$$

where η is the viscosity of oxygen. When 0.01<Kₙ<10, both Knudsen flow and viscous flow exist and the combined mass transfer coefficient across the membranes 302 is:

$${k}_{m} = {k}_{m , Kn} + {k}_{m , vis} = \frac{2}{3} {( \frac{8 {M}_{w}}{π RT} )}^{0.5} \frac{{ɛ r}_{p}}{δτ} + \frac{1}{8 η} \frac{{ɛ r}_{p}^{2}}{δτ} \frac{{M}_{w} {P}_{m}}{RT} \qquad ( 18 )$$

General Characteristics of the Membranes

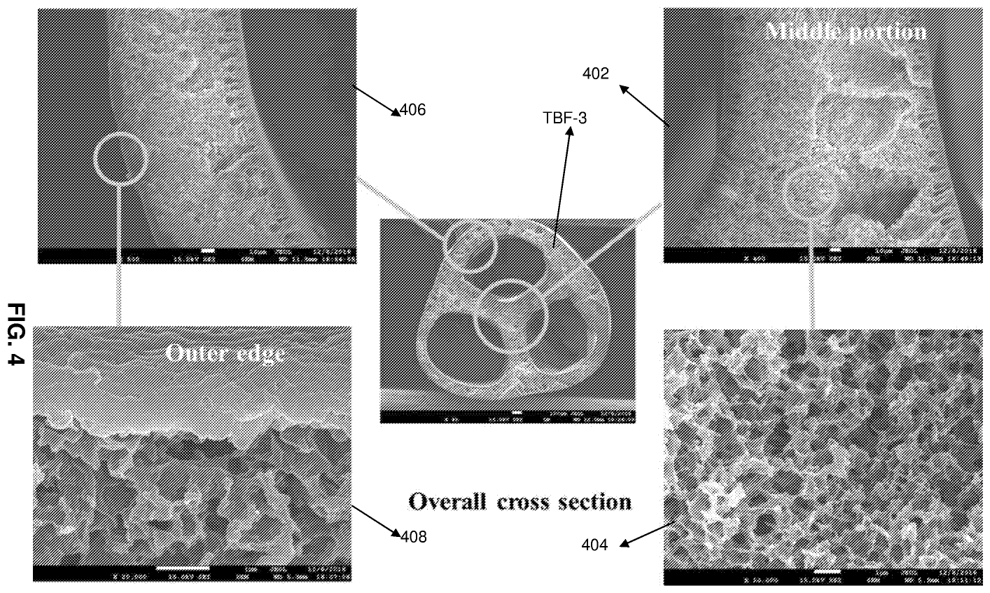

All the five groups of TBF (Tri-Bore Fiber) membranes TBF-1 to TBF-5 in Table 1 have similar triangular outer geometry with three round bores evenly distributed in the center. Using TBF-3 in Table 1 as an example, the typical morphology of the TBF-3 membrane is shown in FIG. 4. In the center of FIG. 4 a cross-section of a fiber of the TBF-3 membrane is shown.

Diagram 402 in FIG. 4 shows a middle portion located at a central portion of the TBF-3 fiber. With reference to Diagram 406, the TBF-3 fiber has relatively dense skin at surfaces of the inner and outer walls for contacting fluid during filtration because both the bore fluid and external coagulant used for the spinning contain high percentage of water, i.e., 80 wt % and 70 wt %, respectively. Denser skin means smaller pores and the denser skin is found proximate to external surfaces of the inner and outer walls. Less dense skin with larger pores is found further inwards at positions non-proximate to the external surfaces of the inner and outer walls. Such double-skin structure is able to protect the membrane from pore blockage by suspended solids either running the feed water at the shell or lumen side. The TBF-3 fiber has a wall thickness of around 120 μm with an average diameter of the inner bore channels around 760 μm. Diagram 404 shows an enlarged view of a centre (i.e. located at position non-proximate to the surfaces of the inner and outer walls) of the central portion of the TBF-3 fiber. Diagram 408 shows an enlarged view of the denser skin forming an outer edge of the TBF-3 fiber and more porous portions further from the denser skin.

Compared with multi-bore hollow fibers (i.e. more than 3 bores) with a round geometry, this triangular configuration (formed by 3 bores) of TBF-3 offers a relatively more uniform fiber wall thickness which favors mass transport and higher ratio of inner surface to fiber cross-section area. A layer of finger-like macro voids could be found near the inner edges of the fibers probably due to the rapid phase inversion and nonsolvent (i.e., water) intrusion. While a sponge-like porous structure is formed close to the outer surface owing to the delayed demixing, the solvent-nonsolvent exchange is retarded by the outer skin formed.

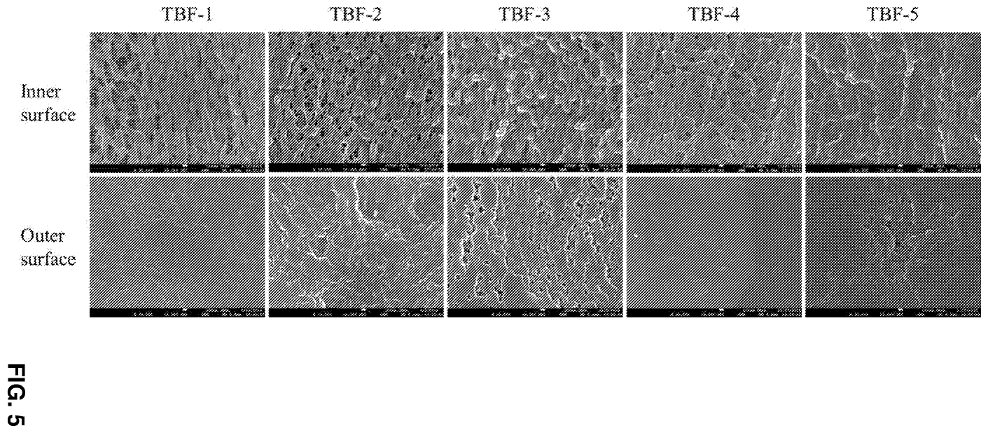

FIG. 5 illustrates the inner and outer surface morphologies of the TBF-1 to TBF-5 membranes in Table 1, which are fabricated from different spinning conditions. Based on 12 and 13 wt % polymer concentrations and NMP/water bore fluid, TBF-1 and TBF-2 membranes have porous inner surfaces. When the polymer concentration increases to 15 wt %, the inner surfaces of TBF-3 and TBF-4 membranes is less porous no matter whether NMP/water or water is used as the bore fluid. A polymer concentration of 17 wt % and the bore fluid of water result in dense inner surface. For all the membrane samples fabricated using water as the external coagulant, the outer surface is relatively tighter, consisting of interconnected globules with different degrees of interconnectivity. The only membrane sample having porous outer surface is TBF-3, which is fabricated using NMP/water (30/70 wt %) as the external coagulant.

It should be also noted that longer air-gap distance of 15 cm was used for the fabrication of the TBF-3 membrane. Appropriate stretching after the nascent fibers are extruded from the spinneret might also contribute to its porous structure. Poor spinnability was observed for the dope solutions containing relatively low concentration of polymer (e.g., 12 or 13 wt %). Adding LiCl could increase the viscosity of the dope solutions, but the amount of LiCl has to be carefully controlled because it reduces the solubility of PVDF in NMP. Porous structure is preferable for water deoxygenation and this is why PEG400 is used as pore former. However, the dope solution tends to gel and is difficult to spin if the PEG concentration reaches 7 wt %.

Although TBF-1 to TBF-5 are all viable examples of the desired membrane that is created, TBF-3 has the best the spinnerability and preferable membrane structure. Hence, the characterization and deoxygenation tests presented in the present disclosure are mainly focused on the TBF-3 membrane.

When reference is made to plurality of TBF-3 membranes in the present disclosure, this refers to a bundle of individual fibers of the TBF-3 membrane.

Table 2 below summarizes the general characteristics of the as-spun tri-bore TBF-3 hollow fiber membranes listed in Table 1. The TBF-3 membranes have a porosity of 75% which is beneficial for the fast transport of oxygen. A water contact angle of 94° indicates the necessary hydrophobicity, which helps to prevent the liquid water from entering the membrane pores at operating pressure. It should be noted that the contact angle was measured for the fiber outer surface. The tri-bore hollow fiber membranes exhibit excellent stretchability in view of the elongation at break about 3-5 times higher than previously developed multibore hollow fibers. The maximum load is about 2-3 times higher than that of single-bore PVDF hollow fiber membranes fabricated based on a similar formulation.

TABLE 2
Characteristic properties of the TBF-3 membrane

| | | | | | | Water |
|---|---|---|---|---|---|---|
| | Inner | Maxi- | Elongation | Tensile | | contact |
| | diameter | mum | at break | stress | Porosity | angle |
| Membrane | (mm) | load (N) | (%) | (MPa) | (%) | (°) |
| TBF-3 | 760 | 3.03 | 37.81 | 1.27 | 75 | 94 |

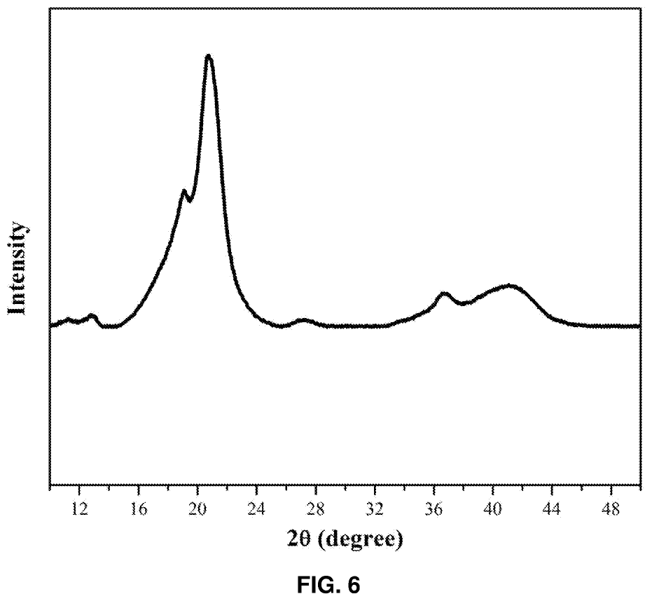

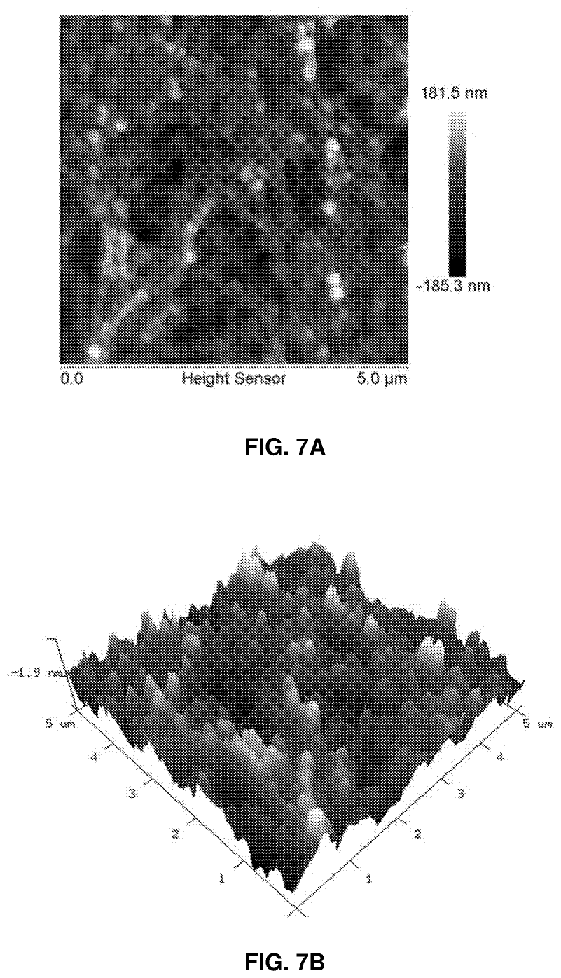

FIG. 6 shows the X-ray diffraction pattern of the TBF-3 membrane. The strong peak at 26=20.7°, assigned to the reflection of the (200) and (100) planes, and weak peaks at 36.6 and 42.2° are the characteristics of p phase crystal structure of the material PVDF. The two-dimensional AFM image shown in FIG. 7A clearly illustrates the porous structure of the membrane inner surface. As seen from the three-dimensional AFM image in FIG. 7B, a large number of very tiny nodules exist at the inner surface. This is an indication that the TBF-3 membrane offers high contact area, which is favorable for accelerated mass transport. The mean roughness (Ra) of the inner surface is 34.9 nm and the root mean square value (Rms) is 44.7 nm. The maximum vertical difference between the highest and lowest data points (Rmax) is 365 nm, indicating a moderate roughness.

Performance for Water Deoxygenation

The deoxygenation performance of the membrane contactors packed with tri-bore hollow fiber membranes, in particular the TBF-3 membrane was studied under a vacuum condition of around 3000 Pa. The setup used for this performance test is the same as that of FIG. 3.

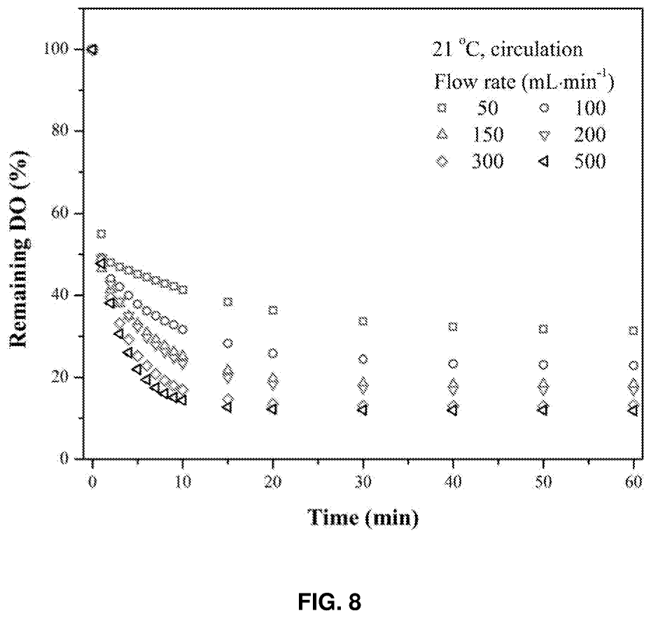

FIG. 8 shows a chart of remaining DO level present in filtered fluid in percentage vs time in minutes. Graph plots for 6 flow rates, specifically, 50, 100, 150, 200, 300 and 500 in mL min⁻¹, are shown. FIG. 8 presents the deoxygenation performance at different flow rate at a circulation mode i.e. a common pool of fluid or water is recirculated for deoxygenation. At the room temperature of 21° C., DI water is saturated with oxygen at about 8.89 ppm and it is the initial DO level presented as 100%. An obvious drop of the DO level can be seen in the first few minutes and the decline becomes slow afterwards. For each water flow rate, the DO level is almost constant after 30 minutes. With increase of the water flow rate, DO is removed faster and the final DO concentration is lower. At a flow rate of 500 mL min⁻¹, the lowest DO concentration of 1.05 ppm in the product water is achieved and this corresponds to a DO removal percentage of 88.19% (remaining DO of 11.81%).

The relatively high DO removal ability is consistent with the TBF-3 membrane morphology analysis discussed above. The remaining DO concentrations are in the range of 1.07-2.99 ppm after 30 min deoxygenation test. It should be noted that the DO removal efficiency is not as high as expected due to the much smaller membrane area and non-optimized experimental conditions.

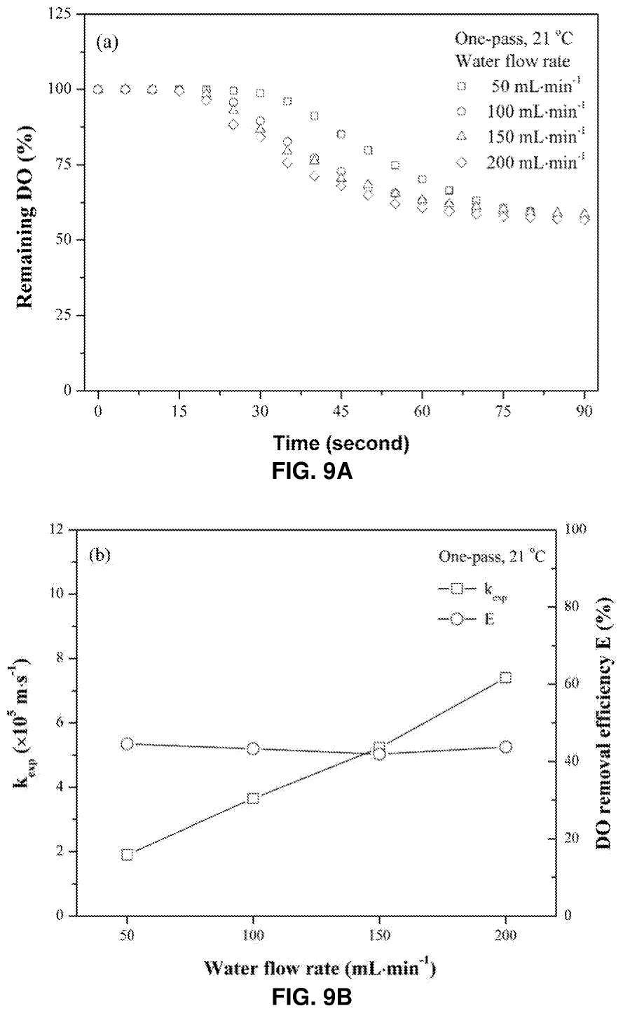

FIG. 9A shows a chart of remaining DO (Dissolved Oxygen) level present in filtered fluid in percentage vs time in seconds. FIG. 9A presents the deoxygenation performance at different flow rates at a single-pass mode i.e. one time filter with no recirculation of fluid or water. Graph plots for 4 flow rates, specifically, 50, 100, 150, and 200 in mL min⁻¹ are shown in FIG. 9A. For the same single-pass mode, FIG. 9B shows DO removal efficiency E in percentage and experimental mass transfer co-efficient kₑₓₚ (×10⁵ m s⁻¹) (equation (7)) vs water flow rate (mL min⁻¹). In the single-pass mode, the outlet DO changes with the water flow rate in the first 90 seconds and it is almost identical subsequently as shown in FIG. 9A.

Eventually, the DO removal efficiency is not very different although the mass transfer is enhanced during a short period of time with increase in the water flow rate as shown in FIG. 9B. It is not surprising that kₑₓₚ has same values after 90 seconds. This is different from previous observations at the same operation mode, i.e., higher flow rate usually giving rise to a higher mass transfer coefficient but a lower DO removal efficiency. The possible reason is that the flow rate used in this study is relatively low due to the limitation from the experimental facility and its change is also small. Higher mass transfer coefficient at a faster water flow rate is reasonable because the resistance for the oxygen transport mainly lies in the liquid phase while the change in hydraulic conditions does affect the mass transfer rate within the water boundary layer at the membrane surface.

It can be extrapolated that the solubility and the diffusion rate of DO in the bulk water do not significantly influence the overall mass transfer. When the deoxygenation is conducted at the single-pass mode, kₑₓₚ increases from 1.90×10⁻⁵ to 3.64×10⁻⁵, 5.22×10⁻⁵ and 7.40×10⁻⁵ m s⁻¹ when the water flow rate is increased from 50 to 100, 150 and 200 mL min⁻¹, respectively, in the initial stage of the experiment. The mass transfer coefficients observed for the tri-bore hollow fiber membranes (TBF-3) are in the same range as those which have been reported for other similar membranes.

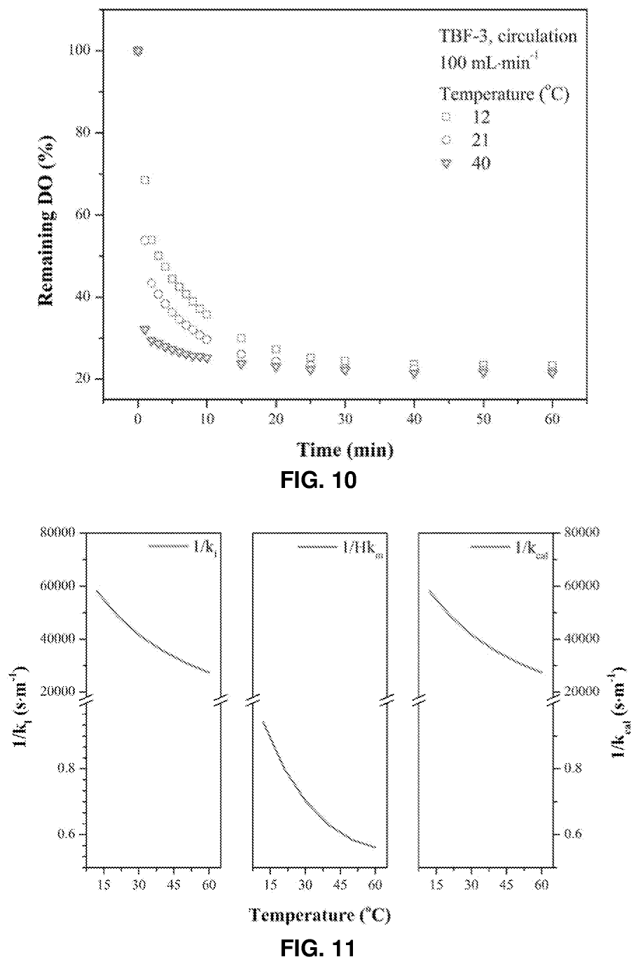

The influence of operating temperature on the deoxygenation performance was studied at the circulation mode at a fixed water flow rate of 100 mL min⁻¹ in FIG. 10. FIG. 10 shows a chart of remaining DO level present in filtered fluid in percentage vs time in minutes. Graph plots for 3 temperatures, specifically, 12, 21, and 40 in degrees Celsius are shown. The remaining DO level drops faster in the first 15 min at higher temperatures. After 30 min, the remaining DO concentrations are close to each other and are almost independent on the temperature. Obviously, the solubility of oxygen in water drops when the temperature increases and its diffusion is faster. This might explain the DO change observed at the early stage of the experiments. kₑₓₚ has values of 2.19×10⁻⁵, 2.43×10⁻⁵ and 2.43×10⁻⁵ m s⁻¹ at temperatures of 12, 21 and 40° C., respectively, for the tri-bore hollow fiber membranes (TBF-3) (see Table 3 below).

TABLE 3
Experimental mass transfer.

| | kₑₓₚ (×10⁵ m s⁻¹)* | | |
|---|---|---|---|
| Membrane | 12° C. | 21° C. | 40° C. |
| TBF-3 | 2.19 | 2.43 | 2.43 |

*Water circulation rate: 100 mL min⁻¹

To further understand the transport of oxygen across the membrane, equations 9-18 above were used to calculate the theoretical mass transfer coefficient. With increase in the water temperature, the resistance at the liquid side decreases significantly due to decreased water viscosity and increased oxygen diffusivity within the boundary layer. This is illustrated by FIG. 11, which is a chart of 1/kₗ (s·m⁻¹) and 1/k_{cal} (s·m⁻¹) vs temperature (degrees Celsius). It is observed that at different temperatures, vacuum levels or water flow rates, Kₙ always has values above 100 while k_{m,Kn} is 10-300 times higher than k_{m,vis}. Therefore, Knudsen diffusion dominates the transport of oxygen across the TBF-3 membrane.

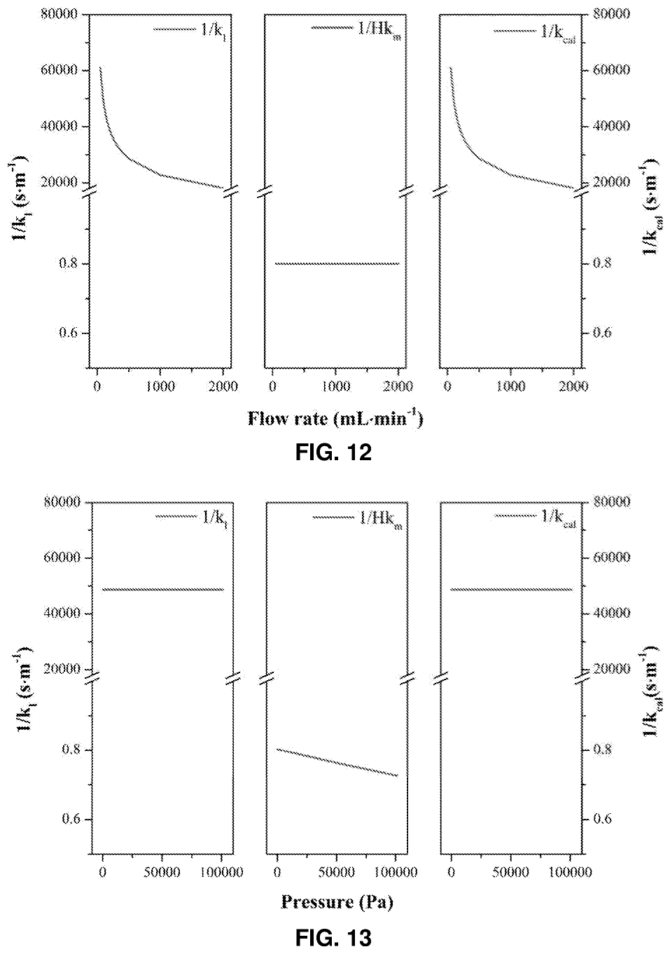

The resistance to oxygen transport through the TBF-3 membrane increases at enhanced temperatures due to higher viscosity of oxygen as well as more vigorous collisions between oxygen molecules and the membrane pore wall. Nevertheless, the resistance contributed by the membrane is still much lower than that from the liquid phase. Increasing the water flow rate favors the overall mass transfer coefficient while the influence becomes smaller when the water flow rate is above 500 mL min⁻¹. This is illustrated by FIG. 12, which is a chart of 1/kₗ (s/m) and 1/k_{cal} (s/m) vs flow rate (mL min⁻¹). It is noted that water is at laminar flow at the experimental conditions in this study. Still, the resistance created by the TBF-3 membrane is low and negligible. The increase in the water flow rate enhances the transport of oxygen through the water boundary layer at the TBF-3 membrane surface, but the corresponding resistance is still more than 20000 times of that in the membrane phase. Improving the vacuum at the membrane shell side only slightly decreases the mass transfer resistance across the membrane. This is illustrated by FIG. 13, which is a chart of 1/kₗ (s/m) and 1/k_{cal} (s/m) vs Pressure (Pa). However, its influence is very small and the overall resistance is almost unchanging. It could be concluded that the deoxygenation through the tri-bore hollow fiber membranes (TBF-3) is dominated by the mass transfer at the liquid water side. This is consistent with the previous observations made in respect of single-bore hollow fiber membranes. The above analysis provides valuable guidance for the further development of tri-bore hollow fiber membranes, i.e. to optimize the membrane surface characteristics such as roughness, number of pores, and surface chemistry in order to enhance the mass transfer rate.

In the above-described examples, novel tri-bore PVDF hollow fiber membranes were developed for water deoxygenation applications. The physiochemical properties of the membranes and their deoxygenation performance under different conditions were studied. Triangular shape tri-bore PVDF hollow fiber membranes were prepared using a tri-bore blossom spinneret. The as-spun PVDF membranes mainly contained β-phase crystal, exhibiting a porous inner surface and a relatively tight outer surface.

The tri-bore hollow fiber membranes exhibited excellent mechanical strength. The maximum load, elongation at break, and tensile stress could reach 3.90 N, 37.81% and 1.27 MPa. Therefore, the tri-bore hollow fiber membranes would have enough mechanical strength to resist the pressure from the water flow in real applications. The as-prepared membranes showed a porosity of 75% and a water contact angle of 94°, making them a good candidate for the water deoxygenation and even other water degassing purposes. The DO removal rate could be enhanced with the increase in the water flow rate and the operating temperature. Theoretical analysis were consistent with the experimental observations.

In an example of the present disclosure as follows, there is provided a robust tri-bore PVDF hollow fiber membranes used for the control of dissolved oxygen in normal city water.

Membrane Materials

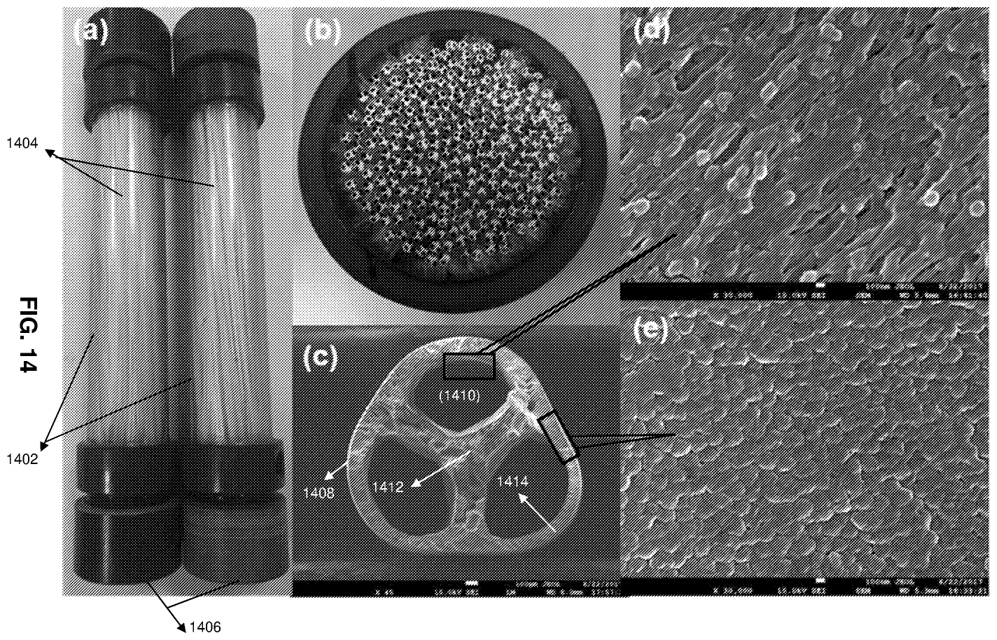

With reference to FIG. 14, diagram (a) shows two 1.5 inch membrane modules 1402 connected in series and used for deoxygenation experiments. Each module 1402 contains 200 pieces of freeze-dried PVDF tri-bore hollow fibers 1404 with the two ends sealed using epoxy resin to a respective membrane contactor 1406. Diagram (b) of FIG. 14 shows the ends of the freeze-dried PVDF tri-bore hollow fibers 1404 in a membrane contactor 1406 with a cover of the membrane contactor 1406 removed. Diagram (c) of FIG. 14 shows a cross-sectional view of a tri-bore hollow fiber 1408 comprising three channels. The tri-bore hollow fibers of the modules 1402 were produced via a dry-jet wet phase inversion spinning process. The effective length of the hollow fibers in each membrane module 1402 is about 24 cm. The morphology of the PVDF hollow fiber membranes 1404 shown in FIG. 14 was inspected using a Field Emission Scanning Electron Microscope (FESEM, JEOL JSM-7600F, Japan). For the FESEM inspection i.e. to generate diagrams (d) and (e) of FIG. 14, the membrane samples were fractured and coated with platinum using a sputtering coater (JEOL JFC-1600, Japan). Diagram (d) shows pore sizes at a surface of an inner channel wall of a channel 1410 of the tri-bore hollow fiber 1408 for contacting fluid running through the channel and diagram (e) shows pore sizes proximate to an external surface of the tri-bore hollow fiber 1408 for contacting fluid external of the tri-bore hollow fiber 1408.

Deoxygenation Experiments

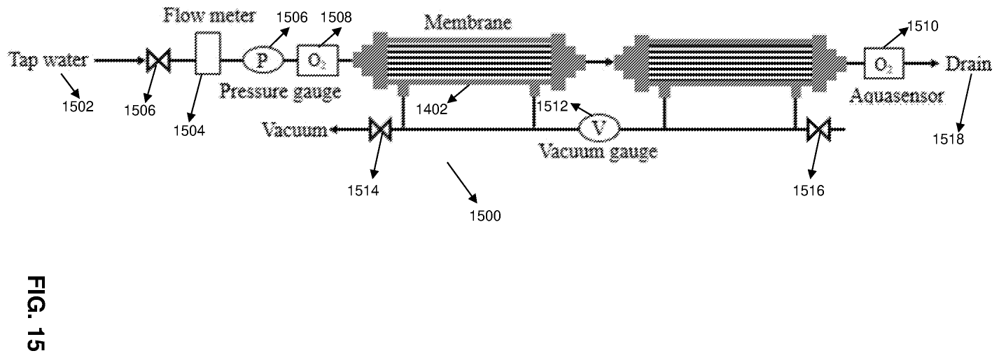

With reference to FIG. 15, the two membrane modules 1402 was mounted into a lab-scale experimental setup 1500 and examined for deoxygenation. City tap water 1502 was continuously introduced to a lumen side of the hollow fiber membranes 1402 at room temperature (25° C.) and was drained to a drain outlet 1518 after passing through an Aqua sensor (Thermo Scientific) 1510 that is used to check concentration of dissolved oxygen. The water flow rate and pressure before the membrane modules 1402 were monitored throughout the experiment using a flowmeter 1504 and a pressure gauge 1506 respectively. A valve 1506 connected to a source of the city tap water 1502 controls the flow of the water and the valve 1506 is placed before the flowmeter 1504. The concentration of dissolved oxygen is monitored at positions before and after the membrane modules 1402 by aqua sensors 1508 and 1510 respectively throughout the experiment. Vacuum was applied (see arrow for Vacuum in FIG. 15) at a shell side of the membranes 1402 using an appropriate vacuum pump (not shown) and the vacuum level was controlled at different levels. A vacuum gauge 1512 is used to monitor the vacuum level. A valve 1514 is provided at the vacuum application side and a valve 1516 is provided along a pipe after the membrane module. The valve 1516 works with the valve 1514 to provide vacuum control at the shell side of the membranes 1402.

Two sets of experiment were carried out. For the first set of experiment, city water 1502 was controlled at different flow rates, i.e., 20, 100, 300, 500, 700 and 900 mL min⁻¹, respectively, with the shell side of the membranes 1402 at the same vacuum of 29 inHg. For the second set of experiment, the vacuum level at the shell side of the membranes 1402 was controlled at 11, 14, 17, 20, 23, 26 and 29 inHg.

Equations Pertaining to Mass Transfer Coefficient

The mass transfer coefficient used to quantify mass transfer in the liquid phase can be calculated from Leveque equation:

$$\frac{{k}_{l} {d}_{i}}{{D}_{l}} = 1.62 {( \frac{{d}_{i}^{2} \overline{v}}{{LD}_{l}} )}^{1 / 3} \qquad ( 20 )$$

The mass transfer coefficient in a hydrophobic membrane is:

$${k}_{m} = {D}_{p} \{ \frac{ɛ}{τ b} \} \qquad ( 21 )$$

Where Dₚ, τ, and b denote the diffusivity of oxygen in the membrane pore, the tortuosity of the pore and the membrane thickness, respectively. In the membrane pores, the transport of oxygen is through Knudsen diffusion and the diffusivity can be estimated using the following equation:

$${D}_{p} = \frac{{d}_{p}}{3} {( \frac{8 RT}{{π M}_{w}} )}^{1 / 2} \qquad ( 22 )$$

where Dₚ is the mean pore diameter and MW is the molecular weight of oxygen.

Equations Pertaining to Concentration Profile of Oxygen

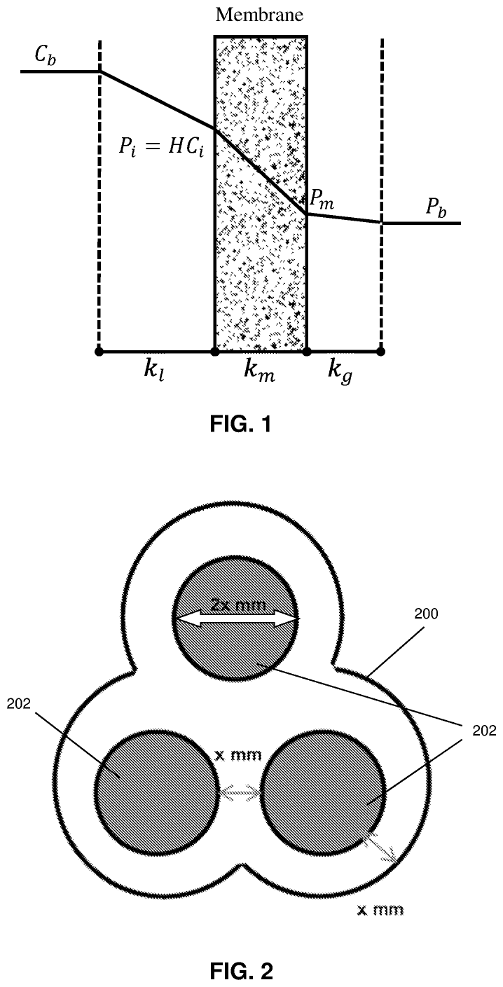

FIG. 1 is a schematic diagram of the transport of oxygen with water flowing in a lumen side of a hollow fiber membrane as well as the concentration profile at different phases. The equation for steady state two-dimensional flow in the lumen side can be written as:

$${v}_{z} \frac{\partial C}{\partial z} = {D}_{l} \frac{{\partial }^{2} C}{\partial {z}^{2}} + \frac{D}{r} \frac{\partial }{\partial r} ( r \frac{\partial C}{\partial r} ) \qquad ( 23 )$$

where C, Dₗ, r and v_{z} denote the local concentration of oxygen, the diffusivity of oxygen in water, the radial distance and the axial velocity of water. The velocity profile in z direction can be obtained as:

$${v}_{z} ( r ) = 2 \overline{v} \{ 1 - {( \frac{r}{R} )}^{2} \} \qquad ( 24 )$$

where v is the average velocity of water in the lumen and R is the radius of the fiber lumen. The boundary conditions for equation (23) are as follows:

$$z = 0 , \\ {C}_{( r , 0 )} = {C}_{in , b} \\ r = 0 , \\ {C}_{( 0 , z )} = 0 is finite {or [ \frac{\partial C}{\partial r} ]}_{0 , z} = 0 \\ {C}_{( R , z )} = {C}_{R} = {C}_{i} \qquad ( 25 )$$

The following dimensionless form could be considered to express equation (23).

$$θ = \frac{C - {C}_{i}}{{C}_{0} - {C}_{i}} , \\ Y = \frac{r}{R} , \\ Z = \frac{z}{{RP}_{e}} \qquad ( 26 )$$

where Pₑ is the Peclet number defined as Pₑ=Rv₀/D. Substituting these dimensionless variables into equation (23) gives

$$( 1 - {Y}^{2} ) \frac{\partial θ}{\partial Z} = \frac{1}{{Pe}^{2}} \frac{{\partial }^{2} θ}{\partial {Z}^{2}} + \frac{1}{Y} \frac{\partial }{\partial Y} ( Y \frac{\partial θ}{\partial Y} ) \qquad ( 27 )$$

Boundary conditions for equation (27) are as follows:

$$θ ( Y , 0 ) = 1 , \\ θ ( 1 , Z ) = 0 , \\ θ ( 0 , Z ) is finite or \frac{\partial θ}{\partial Y} ( 0 , Z ) = 0 \qquad ( 28 )$$

The values for Pₑ are generally large (Pₑ>100). Therefore, it is valid to assume

$$1 / P {e}^{2} ⪡ 1 and \frac{1}{{Pe}^{2}} \frac{{\partial }^{2} θ}{\partial {Z}^{2}} \approx 0 .$$

Neglecting the item

$$\frac{1}{{Pe}^{2}} \frac{{\partial }^{2} θ}{\partial {Z}^{2}}$$

in equation (27), the solution of the simplified equation is:

θ(Y,Z)=Σₙ₌₁^{∞}Aₙe^{-λ}^{ₙ}^{^{z}}_{Z}Φₙ(Y) (29)

In equation (29), Φn(Y) is the eigen function of a proper Sturm-Liouville system:

$${λ}^{2} ( 1 - {Y}^{2} ) Φ + \frac{1}{Y} \frac{\partial }{\partial Y} ( Y \frac{\partial Φ}{\partial Y} ) = 0 \qquad ( 30 )$$

Boundary conditions of equation (30) are:

$$\frac{d Φ}{dY} ( 0 ) = 0 or Φ ( 0 ) is finite , Φ ( 1 ) = 0 \qquad ( 31 )$$

Defining X=λY² and substituting it into equation (30) gives

$$X \frac{{\partial }^{2} W}{\partial {X}^{2}} + ( 1 - X ) \frac{dW}{dX} + ( \frac{λ}{4} - \frac{1}{2} ) W = 0 \qquad ( 32 )$$

Equation (31) is known as Kummer's equation and has two solutions, i.e., the Kummer function of the first kind

$$M ( \frac{1}{2} - \frac{λ}{4} , 1 , X )$$

and the Tricomi function

$$T ( \frac{1}{2} - \frac{λ}{4} , 1 , X )$$

considering the boundary condition of Φ(0) and W(0), only

$$M ( \frac{1}{2} - \frac{λ}{4} , 1 , X )$$

is the valid solution of equation (32):

$$W ( X ) = M ( \frac{1}{2} - \frac{λ}{4} , 1 , X ) \\ M ( \frac{1}{2} - \frac{λ}{4} , 1 , X ) = 1 + \frac{a}{b} X + \frac{a ( a + 1 ) {X}^{2}}{b ( b + 1 ) 2 !} + … + \frac{a ( a + 1 ) … ( a + n - 1 ) {X}^{n}}{b ( b + 1 ) … ( b + n - 1 ) n !} + … \qquad ( 33 )$$

where a=½−λ/4. The item Aₙ in equation (29) might be determined by:

$${A}_{n} = \frac{{\int }_{0}^{1} {Φ}_{n} ( Y ) Y ( 1 - {Y}^{2} ) dY}{{\int }_{0}^{1} {Φ}_{n}^{2} ( Y ) Y ( 1 - {Y}^{2} ) dY} \qquad ( 34 )$$

The value of A could be determined as follows:

$$Φ ( Y ) = {e}^{- \frac{λ {Y}^{2}}{2}} W ( λ {Y}^{2} ) at Φ ( 1 ) = 0 \qquad ( 35 )$$

Results and Discussion

Membrane Morphology

With reference to FIG. 14, each of the novel tri-bore hollow fibers proposed in an example of the present disclosure that is present in two 1.5 inch membrane modules 1402 has a triangular shape shown in diagram (c) of FIG. 14 with a fiber wall 1414 and a junction 1412 at a center having thickness of about 120 and 200 μm respectively. The thin fiber wall 1414 is favorable for reduction in resistance to oxygen transport while the relative thicker junction 1412 provides strong support to the membrane in order to maintain its integrity. Each fiber of the novel tri-bore hollow fibers has three flow channels 1410, each of which has an average diameter of about 670 μm. To efficiently utilize the membrane area, feed water for the deoxygenation experiments described with reference to FIG. 15 was run inside the hollow fibers. The inner surface of the hollow fiber membranes is apparently porous (See diagram (d)) which is favorable for the transport of oxygen. The outer surfaces are less porous (See diagram (e)), consisting of interconnected globules. The pores within the inner skin layer of the tri-bore hollow fiber membranes are in the range of 2-20 nm and the mean pore radius is 6.3 nm. The membranes in the membrane modules 1402 illustrated by FIG. 14 are in a category of ultrafiltration and LEP value of the membranes in the membrane modules 1402 for water is determined at 9.9 bar.

Performance of Water Deoxygenation

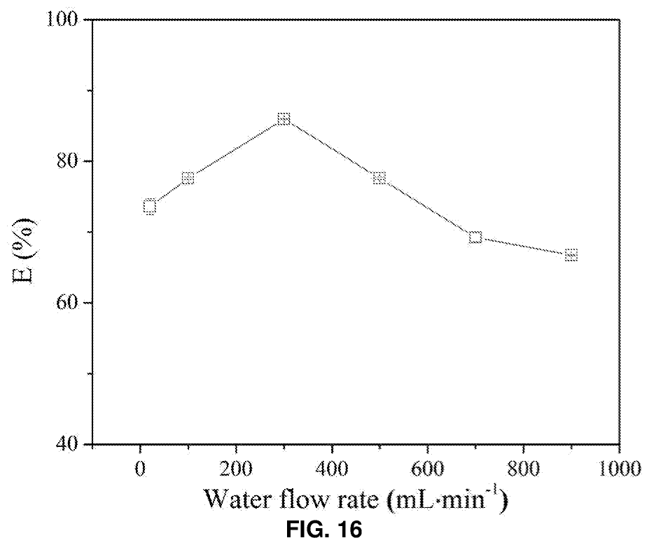

In the fiber lumen side of the membranes in the membrane modules 1402 of FIG. 14, dissolved oxygen needs to diffuse in liquid water towards a water-gas interface and pass through the interface before entering membrane pores as gas molecules. Oxygen molecules are immediately taken away upon continuous suction in the shell side of the membranes in the membrane modules 1402. In the deoxygenation experiments described with reference to FIG. 15 that were conducted, the water flow rate (mL min⁻¹) was found to influence oxygen removal efficiency E (%). The relationship between the water flow rate is represented by equation (4) and results of the deoxygenation experiments are shown in FIG. 16. FIG. 16 shows a graph of oxygen removal (or deoxygenation) efficiency E (%) vs water flow rate (mL min⁻¹).

Interestingly, with reference to FIG. 16, the increase in the water flow rate results in higher deoxygenation efficiency E (%) and reaches a maximum value of 85.95% at 300 mL min⁻¹. Thereafter, the efficiency drops with further increase in the water flow rate. At the highest water flow rate (900 mL min⁻¹) tested in the experiments described with reference to FIG. 15, the oxygen removal efficiency E (%) decreases to 66.75%.

For all the experiments described with reference to FIG. 15, the feed water is absolutely under laminar flow with Reynolds number in the range of 0.54-29.72 (see Table 4 below).

TABLE 4
Reynolds number and mass transfer
coefficients at different water flow rates.

| | Water flow rate (mL min⁻¹) | | | | | |
|---|---|---|---|---|---|---|
| Parameter | 20 | 100 | 300 | 500 | 700 | 900 |
| Re | 0.54 | 2.71 | 8.62 | 14.37 | 20.12 | 29.72 |
| k_{L} (×10⁶ m s⁻¹) | 4.41 | 7.54 | 10.87 | 12.90 | 14.42 | 15.69 |
| k_{M} (×10⁵ m s⁻¹) | 6.43 | 6.44 | 6.450 | 6.462 | 6.467 | 6.468 |
| K (×10⁶ m s⁻¹) | 4.40 | 7.52 | 10.84 | 12.84 | 14.36 | 15.61 |

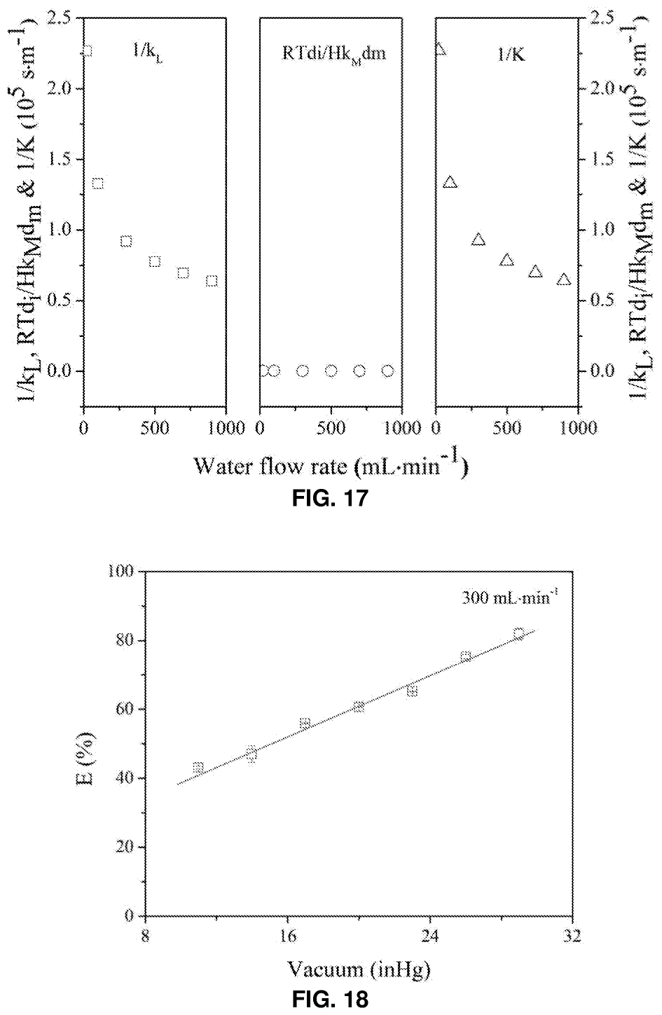

k_{M} is always higher than k_{L} at all water flow rates. With increasing the water flow rate, k_{L} increases significantly while k_{M} does not change much. Within the membrane matrix in the membrane modules 1402 of FIG. 14, the resistance to the movement of oxygen molecules comes from the tortuous or interconnected pore walls. Being hydrophobic, the hollow fiber membranes in the membrane modules 1402 of FIG. 14 does not allow liquid water to enter their pores. Therefore, varying the water flow rate does not apparently influence the transport of oxygen across the membrane pores. The slight change in k_{M} might be caused by change in the temperature due to coupling effect of water evaporation at the water-gas interface of the membranes in the membrane modules 1402 of FIG. 14 as well as the condensation of water vapor in the membrane shell side. The resistance to oxygen transport at different flow rates is shown in FIG. 17. FIG. 17 shows a graph of 1/k_{L}, RTdᵢ/Hk_{M}dₘ & 1/K (10⁵ s m⁻¹) vs water flow rate (mL min⁻¹).

With reference to FIG. 17, with increasing water flow rate, the resistance at liquid phase (1/k_{L}) decreases significantly. Though at laminar flow, faster water flow makes a boundary layer near an inner surface of the membranes in the membrane modules 1402 of FIG. 14 thinner and favors the transport of oxygen to the gas-liquid interface at the aperture of membrane pores of the membranes in the membrane modules 1402 of FIG. 14. However, the increase in the water flow rate hardly influences the resistance of the membrane matrix of the membranes in the membrane modules 1402 of FIG. 14 as liquid water cannot enter the membrane pores. In other words, the flow path for oxygen (i.e., membrane pores) remains intact.

It is also noticed that the resistance at the liquid phase (1/k_{L}) is much higher than that in the membrane (RTd/Hk_{M}dₘ). Therefore, the transport of oxygen in the liquid phase dominates the rate of deoxygenation.

The deoxygenation experiments described with reference to FIG. 15 began at 29 inHg vacuum in the shell side of the membranes in the membrane modules 1402 of FIG. 14. The exiting concentration of dissolved oxygen gradually reduced and would stabilize at a certain level. After maintaining at the same oxygen concentration for at least 30 min, the experiment proceeded to the next vacuum level. Using 300 mL min⁻¹ as an example, the influence of vacuum on the efficiency of oxygen removal is shown in FIG. 18. FIG. 18 shows a graph of oxygen removal (or deoxygenation) efficiency E (%) vs Vacuum (inHg). With reference to FIG. 18, better efficiency E (%) is achieved at increased vacuum levels. Vacuum level in the shell side of the membranes in the membrane modules 1402 of FIG. 14 is not supposed to influence the diffusion of oxygen within the liquid water. At higher vacuum level, the partial pressure of oxygen in the shell side of the membranes in the membrane modules 1402 of FIG. 14 within the membranes as well as at the water-gas interface of the membranes is lower. This might have created larger driving force for the transport of oxygen from liquid water to the gas phase (under vacuum). Additionally, higher vacuum level accelerates the rate of water evaporation at the water-gas interface of the membranes, which in turn enhances the transport of oxygen.

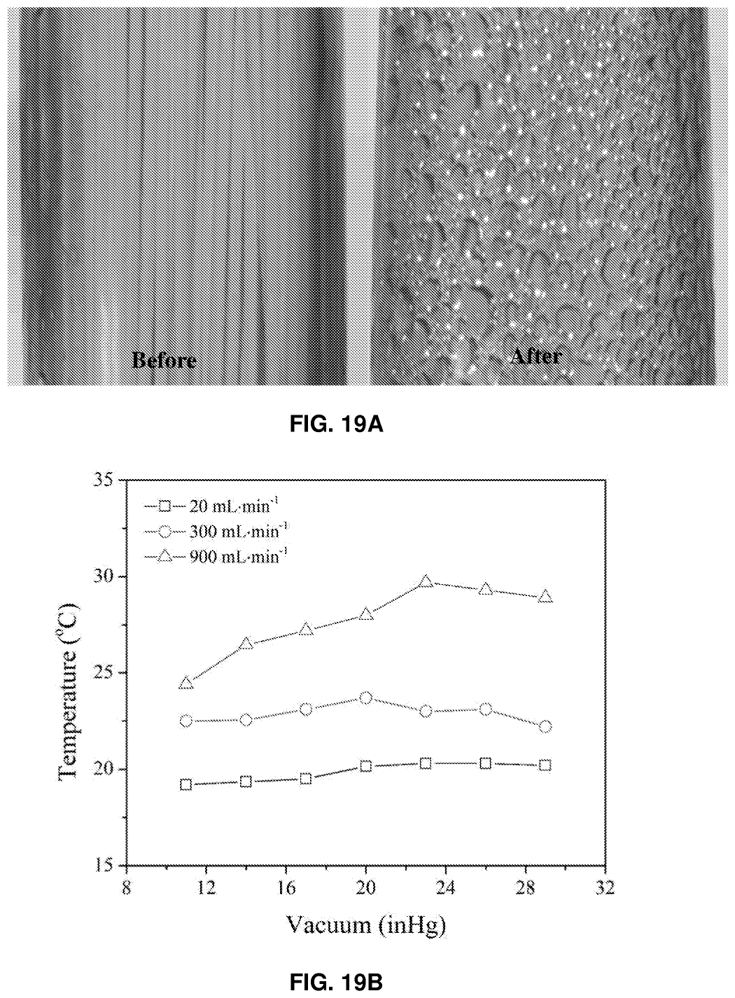

Condensation of water vapor happens at an inner wall of a transparent membrane housing, which is used to enclose the membranes in the membrane modules 1402 of FIG. 14. The condensed water would not disappear even after the deoxygenation experiments described with reference to FIG. 15 are completed. FIG. 19A shows “Before” and “After” images of the inner wall of the transparent membrane housing. Evaporation of water consumes energy and it tends to cool down the liquid water flowing inside the hollow fibers of the membranes. Condensation of water vapor happens at the shell side of the membranes, releasing thermal energy and has a tendency to heat up the hollow fibers and the liquid water in the lumen side of the membranes. Surprisingly, the change in the vacuum level shows different influences on exiting temperature of the liquid water at different water flow rates (See FIG. 19B). FIG. 19B shows exiting temperature (degrees Celsius) of liquid water vs Vacuum (inHg).

With reference to FIG. 19B, when water flows slowly (e.g. 20 mL min⁻¹), it is gradually cooled down when evaporation absorbs thermal energy. As PVDF used to make the membranes in the membrane modules 1402 of FIG. 14 is a poor conductor, the heat transfer rate through the fiber walls of the membranes is slow. Thus, the influence of the thermal energy released from water vapor condensation at the other side of the membrane is much weaker than the cooling effect and this might explain a slight decrease in the exiting temperature of the liquid water at all vacuum levels as shown in FIG. 19B. At medium flow rate (e.g. 300 mL min⁻¹), more condensed water could be seen on the inner wall of the membrane housing like the “After” image in FIG. 19A. The exiting temperature of water slightly increases with reduction in the vacuum level and then drops after reaching a maximum value at 20 inHg vacuum. The difference in the exiting temperature of water at 900 mL min⁻¹ is more obvious. At this water flow rate, more water vapor is generated but the liquid water stays within the membrane modules 1402 of FIG. 14 for much shorter time and the cooling effect lags behind. Condensation of large quantity of water vapor at high vacuum level releases a lot of thermal energy which heats up the whole of the membrane modules 1402 of FIG. 14. This is why the exiting temperature of water slightly increases even though the vacuum level decreases from 29 to 26 and 23 inHg at 900 mL min⁻¹. Further decreasing the vacuum level causes less water vapor to form and condense in the membrane shell side and less thermal energy to be released. Heating effect is still competing with the cooling effect but its influence becomes minor. As a result, the exiting temperature of the liquid water decreases. As it is not possible to avoid the evaporation of the liquid water and the condensation of water vapor, their influence on deoxygenation has to be considered. Further study may be carried out to investigate the water evaporation rate at various operation conditions and the long term influence of water vapor condensation on the mass transfer rate.

Concentration Profiles

The concentration of dissolved oxygen at radial and axial directions within the membrane modules 1402 of FIG. 14 has been calculated using equations (23)-(35). The trend of concentration profiles is similar.

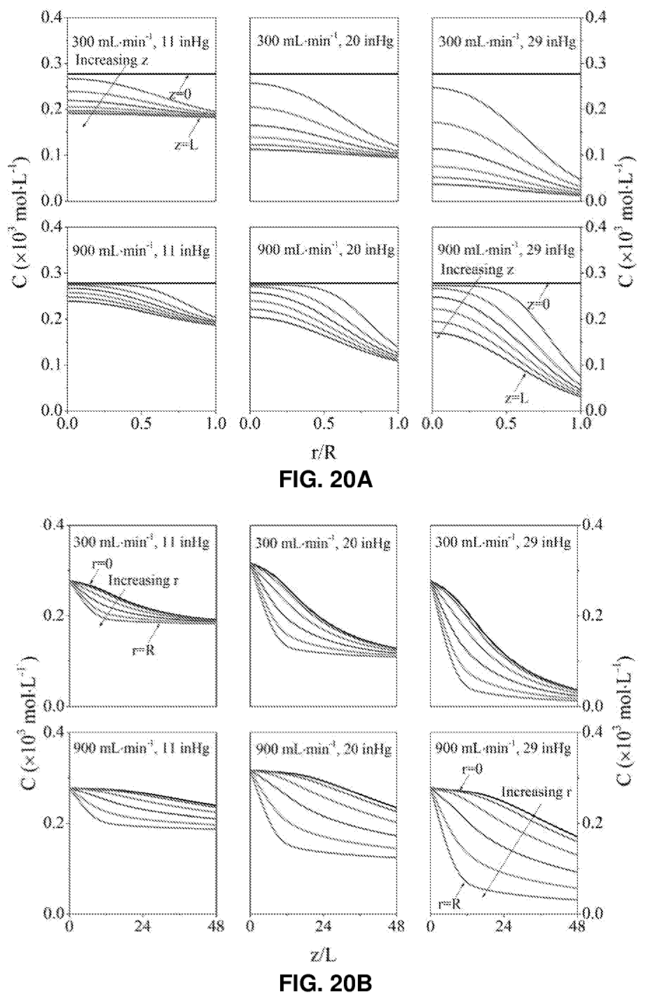

As an example, the radial and concentration profiles at 300 and 900 mL min⁻¹ flow rates and three different vacuum levels are presented and discussed with reference to FIGS. 20A and 20B. FIG. 20A shows graphs of C (×10³ mol L⁻¹) vs r/R (radial relative to fiber wall) at different vacuum levels. FIG. 20B shows graphs of C (×10³ mol L⁻¹) vs z/L (axial relative to fiber wall) at different vacuum levels. As seen from FIG. 20A, the concentration of dissolved oxygen is the highest at the center of hollow fibers of the membrane modules 1402 of FIG. 14 for both flow rates while concentration of dissolved oxygen decreases along the radial direction towards the fiber walls of the hollow fibers. The concentration gradient in the radial direction is small at low vacuum level and it becomes larger with increase in the vacuum level. At the same vacuum level, the concentration of dissolved oxygen drops faster near the fiber center area of the hollow fibers at 300 mL min⁻¹ than 900 mL min⁻¹. However, the concentration of dissolved oxygen drops more rapidly near the fiber wall area at 900 mL min⁻¹. Thinner boundary layer and reduced resistance to oxygen transport at increased water flow rate account for the phenomenon.

Furthermore, the transport of dissolved oxygen from the liquid bulk to the fiber wall area limits the overall mass transfer rate. A relatively slow water flow rate of 300 mL min⁻¹ results in better deoxygenation performance. As shown in FIG. 20B, the influence of the water flow rate and vacuum level on the axial concentration profiles is also quite significant. The concentration profile of dissolved oxygen is only slightly different near the entering of the membrane modules 1402 of FIG. 14 at both flow rates but the difference becomes more obvious along the membrane modules. The axial concentration profiles at different r/R locations becomes dispersed with increasing the vacuum level while the distribution becomes more broad at 900 mL min⁻¹ water flow rate. After the first membrane module (24 cm) of the membrane modules 1402 of FIG. 14, the concentrations of dissolved oxygen are close to exiting values at different r/R locations for 300 mL min⁻¹ flow rate. However, they are still pretty dispersed at 900 mL min⁻¹ at any vacuum level. The effect of the vacuum level on the oxygen removal efficiency seems to be more significant at enhanced water flow rates. From this aspect, the length of the hollow fibers which are bundled up and contained in the membrane module and therefore, the length of the membrane module may be increased if operating at relatively high water flow rates.

In an example of the present disclosure, tri-bore hollow fiber membrane modules (e.g. the membrane modules 1402 of FIG. 14) have been fabricated for water deoxygenation. The morphology of the membranes of the membrane modules is studied. The influences of the water flow rate and vacuum level on the oxygen removal efficiency have been studied. It is found that too slow (e.g. 20 mL min⁻¹) or too high flow rate (e.g. 900 mL min⁻¹) does not favor the deoxygenation performance and a medium flow rate (e.g. 300 mL min⁻¹) is preferable. The highest oxygen removal efficiency is 82% achieved at 300 mL min⁻¹ and 29 inHg vacuum. Water evaporation and water vapor condensation affect the deoxygenation performance but both are not avoidable for vacuum degassing systems. The liquid water temperature would be dropping if each membrane module is operated at low flow rate due to their opposite influences.

Mathematical modeling is also carried out to investigate the transport of oxygen from water to the gas phase through the membranes in the membrane modules. The resistance to oxygen transport mainly lies in the liquid phase while the resistance created by the liquid water is 200-668 times of that created by the membranes in the membrane modules. Either the vacuum level or the water flow rate influences radial and axial concentration profiles of dissolved oxygen within the liquid phase. The best performance appears at medium water flow rate and enhanced vacuum level.

In another example of the present disclosure as follows, there is provided a robust tri-bore PVDF hollow fiber membranes used for the control of dissolved oxygen in aquaculture water.

Materials

In a study conducted, Kynar HSV 900 PVDF supplied by Arkema Inc. was used for the fabrication of tri-bore hollow fiber membranes. N-methyl-2-pyrrolidone (NMP, 99.5%) and polyethylene glycol 200 (PEG200, >99.0%) used in membrane fabrication were supplied by Merck. DI water from Milli-Q (Millipore) system was used in all experiments. The aquaculture water was supplied by a fish farming company in Singapore. Whatman® grade 1 filter paper with pore size of 11 μm was used for the pre-treatment of the aquaculture water.

Preparation and Characterization of Tri-Bore Hollow Fiber Membranes

The tri-bore hollow fiber membranes were fabricated via a dry-jet wet phase inversion spinning process. Briefly, the dope solution and bore fluid were supplied at specified flow rates by ISCO syringe pumps (Teledyne, 1000D). After entering a coagulation bath, the nascent fibers precipitated and were collected by a take-up roller. Detailed spinning conditions are summarized in Table 5. After spinning, the as-spun tri-bore hollow fiber membranes were immersed in tap water for 2 days to completely remove the residual solvent and additives. The fibers were then frozen in a refrigerator and dried overnight in a freeze drier (S61-Modulyo-D, Thermo Electron).

TABLE 5.
Spinning conditions of tri-bore HF membranes.

| Polymer concentration (wt %) | 15 |
|---|---|
| Additive | PEG200 (5 wt %) |
| Dope flow rate (mL min⁻¹) | 7.5 |
| Bore fluid | Water, 25° C. |
| Bore flow rate (mL min⁻¹) | 2.0 |
| External coagulant | Water, 40° C. |
| Air-gap (cm) | 10 |
| Take up speed (m min⁻¹) | Free-fall |
| Temperature (° C.) | 25 |
| Room humidity (%) | 65-75 |

Membrane morphology was inspected using a Field Emission Scanning Electron Microscope (FESEM, JEOL JSM-7600F). For FESEM inspection, membrane samples were fractured cryogenically in liquid nitrogen and coated with platinum using a sputtering coater (JEOL JFC1600). Dynamic contact angle of the outer surface of the fibers was measured using a Dataphysics DCAT21 tensiometer. Five measurements were made and the results were averaged for reporting. The membrane porosity was calculated using equation (3).

The mean pore radius and the probability density function curve of the pore radius distribution were obtained from the rejections to the neutral solutes. The tri-bore hollow fibers were soaked with ethanol so that they became permeable for liquid water.

Deoxygenation Experiments

The deoxygenation performance of the freeze-dried tri-bore hollow fiber membranes was evaluated through a pilot-scale degassing system as shown in FIG. 3. Prior to the tests, two membrane modules were prepared by bundling the fibers into 1.5 inch PVC casing with the two ends sealed using epoxy resin. Every membrane module contained 200 pieces of fibers with an effective area of 0.3 m². For the deoxygenation tests, DI water was pumped to the lumen side of the hollow fibers while vacuum was applied in the shell side. Circulation operation modes was adopted, i.e., 4 L water was being used and it flows back to the watertank after exiting from the membrane module. All the experiments were conducted at fixed temperatures controlled by using a water circulator (Julabo F12). The deoxygenation performance under different operation modes and flow rates was firstly examined using DI water feed in order to avoid the possible influence of membrane fouling. Fish pond water was then used in the deoxygenation experiments.

Concentration Profile

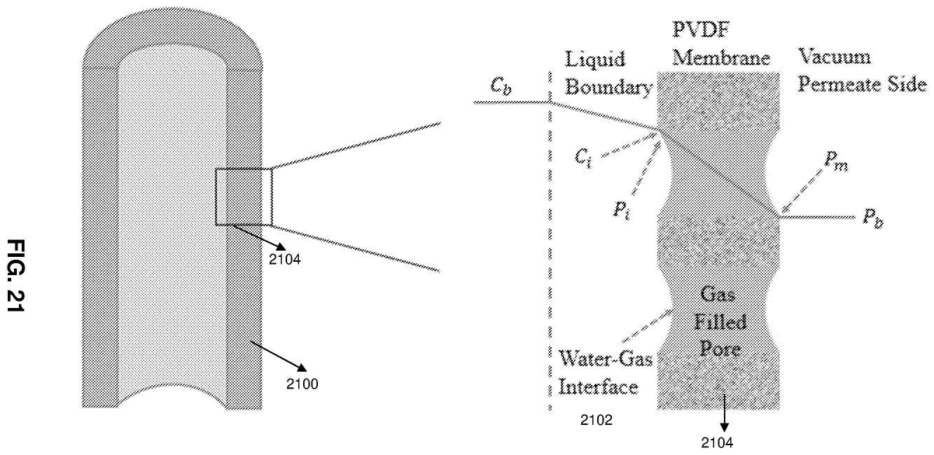

FIG. 21 is a schematic diagram illustrating mass transport of oxygen with water flowing in the lumen side of the aforementioned freeze-dried tri-bore hollow fiber membrane 2100 as well as the concentration profile at different phases. A portion 2104 of the membrane 2100 is enlarged in the illustration by FIG. 21. The concentration of dissolved oxygen at radial and axial directions within the membrane module has been calculated using equations (23)-(35).

Theoretical Mass Transfer Coefficient

At a water-gas interface 2102 of the portion 2104 of the membrane 2100, Henry's law is applicable (Eq. (6)) as water containing DO can be considered as a dilute solution. Since the shell side of the freeze-dried tri-bore hollow fiber membrane 2100 is under vacuum and the interface 2102 is located at the lumen, the resistance at the shell side (permeate side) is negligible. The overall resistance to the transport of oxygen could be expressed using a resistance-in-series concept:

$$\frac{1}{{k}_{0} {d}_{i}} = \frac{1}{{k}_{l} {d}_{i}} + \frac{{R}_{g} T}{H {k}_{p} {d}_{m}} \qquad ( 36 )$$

where k₀, kₗ and kₚ are the mass transfer coefficients of oxygen in water and the membrane pore, R_{g} is the universal gas constant, T is the temperature, and dᵢ and dₘ are the fiber inner diameter and logarithmic mean diameter, respectively. kₗ can be calculated from Leveque equation (Eq. 20) under laminar flow condition:

The mass transfer coefficient in the hydrophobic membrane is:

$${k}_{p} = {D}_{p} \{ \frac{ɛ}{τ b} \} \qquad ( 37 )$$

where Dₚ, τ, and b denote the diffusivity of oxygen in the membrane pore, the tortuosity of the pore and the membrane thickness, respectively. In the membrane pores, the transport of oxygen is through Knudsen diffusion and the diffusivity can be estimated using equation (22).

Flux Analysis

Water is confined in the cylindrical lumen side, so the concentration of DO is not constant along axial position of the fibers. The bulk average concentration (C̅_{b}(z)) of DO in water could be estimated as follows:

$${\overline{C}}_{b} ( z ) = \frac{1}{\overline{ν} S} {\int }_{0}^{R} C ( r , z ) {v}_{z} ( r ) 2 π rdr \qquad ( 38 )$$

where S is the cross-section area of the fiber lumen. The local molar flux of oxygen along at different position of the hollow fiber may be written as:

$$N = {k}_{0} ( {\overline{C}}_{j , b} ( z ) - \frac{{p}_{b}}{H} ) \qquad ( 39 )$$

where p_{b} is the bulk partial pressure of oxygen.

Characteristics of Tri-Bore Hollow Fiber Membranes

As shown in Table 6 below, the inner diameter and outer diameter of the tri-bore hollow fibers are 670 and 1600 μm, respectively. The porosity is about 75%, which is beneficial for fast transport of oxygen. A water contact angle of 94° indicates necessary hydrophobicity, which helps to prevent the entry of liquid water into membrane pores under operating conditions. It should be noted that the contact angle is measured for the outer surface because it is very hard to measure it for the inner surface. As the contact angle is mainly determined by the material (PVDF for this case), the measured contact angle may be considered as an indicator of the hydrophobicity of the membrane. The tri-bore HF membranes are strong and stretchable as indicated by the maximum load at break of 4.04 N, the tensile stress of 6.77 MPa and the elongation of 52.3%.

TABLE 6
Characteristics of tri-bore HF membranes.

| | Inner | Outer | | Tensile | Elongation | | Water |
|---|---|---|---|---|---|---|---|
| | diameter | diameter | Maximum | stress | at break | Porosity | contact |
| Membrane | (mm) | (mm) | load (N) | (MPa) | (%) | (%) | angle (°) |
| Tri-bore hollow | 670 | 1600 | 4.04 | 6.77 | 52.3 | 75 | 94 |
| fiber | | | | | | | |

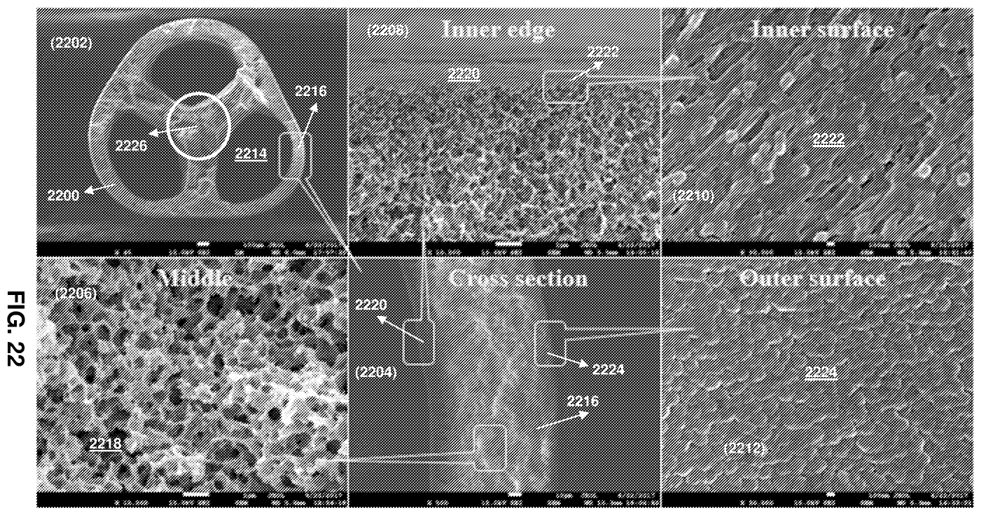

Typical morphology of the as-developed fibers is shown in FIG. 22. FIG. 22 shows 6 images 2202 to 2212 of a fiber 2200 of the membranes comprising 3 bores or 3 channels. One of the 3 channels is given a reference numeral of 2214 in image 2202. Image 2202 shows a cross-section of the fiber 2200 of the membranes that is developed. Image 2204 shows an enlarged cross-sectional view of a segment 2216 of a fiber wall of the fiber 2200 that is marked out in the image 2202. Image 2206 shows an enlarged cross-sectional view of a middle portion 2218 of the segment that is marked out in the image 2202. Image 2208 shows an enlarged cross-sectional view of an inner edge 2220 of the segment 2216 that is marked out in the image 2202. The inner edge 2220 refers to the edge of the segment 2216 that is facing the channel 2214. Image 2210 shows a further enlarged cross-sectional view of the inner edge 2220. Specifically, image 2210 shows an inner surface 2222 that constitutes a wall of the channel 2214. Image 2212 shows a further enlarged cross-sectional view of an outer surface 2224 of the fiber 2200 that would be in contact with fluid to be subject to deoxygenation. The outer surface 2224 is disposed at an opposite side of the inner surface 2222.

The fiber wall comprising the segment 2216 and a junction 2226 at a center of the fiber 2200 have thickness of about 120 and 200 μm respectively. The thin fiber wall is favorable for reduction in the resistance to oxygen transport. The relatively thicker junction 2226 provides strong support to the membrane constituting the fiber 2200 so that the membrane can withstand pressure difference under operation and maintain its integrity. A layer of finger-like macrovoids is present underneath the inner surface 2222 probably due to rapid phase inversion and non-solvent (i.e. water) intrusion during manufacturing. The middle portion 2218 and outer surface 2224 of the fiber 2200 have sponge-like porous structure, which might be due to combined effects from pore forming agent, delayed demixing and stretching during manufacturing. PEG200 is used as the pore forming agent and it helps to generate pores and porosity. As a non-solvent additive, the addition of PEG200 also brings the dope closer to gelation points so that the phase inversion is accelerated. Using water as the external coagulant for spinning, the outer surfaces 2224 of the tri-bore hollow fiber membranes is less porous, consisting of interconnected globules. Once the outer skin (i.e. the outer surface 2224) is formed, the solvent-non-solvent exchange is retarded and causes delayed demixing during manufacturing, which is favorable for the formation of porous structure. An air-gap distance of 10 cm was used for the spinning during manufacturing. Appropriate stretching after the nascent fibers are extruded from a spinneret (e.g. 200 of FIG. 2) used during manufacturing might also contribute to the porous inner surface structure. The inner surface 2222 is apparently porous though the bore fluid for spinning is also water. During the spinning, phase inversion is supposed to occur at the bore side rightly after PVDF solution is extruded from the spinneret. The polymer concentration at the inner surface 2222 would increase rapidly and form a relatively dense structure. It should be noted that the outflow of NMP solvent changes the bore fluid from pure water, a strong coagulant, into a dilute aqueous solution of NMP solvent. Even though the amount of outflowed solvent is very small, its impact on the phase inversion of the inner skin layer cannot be neglected as the amount of bore fluid is also very small (2.0 mL min⁻¹). The bore fluid with continuously incoming solvent might make the inner surface 2222 not as dense as of the outer surface 2224.

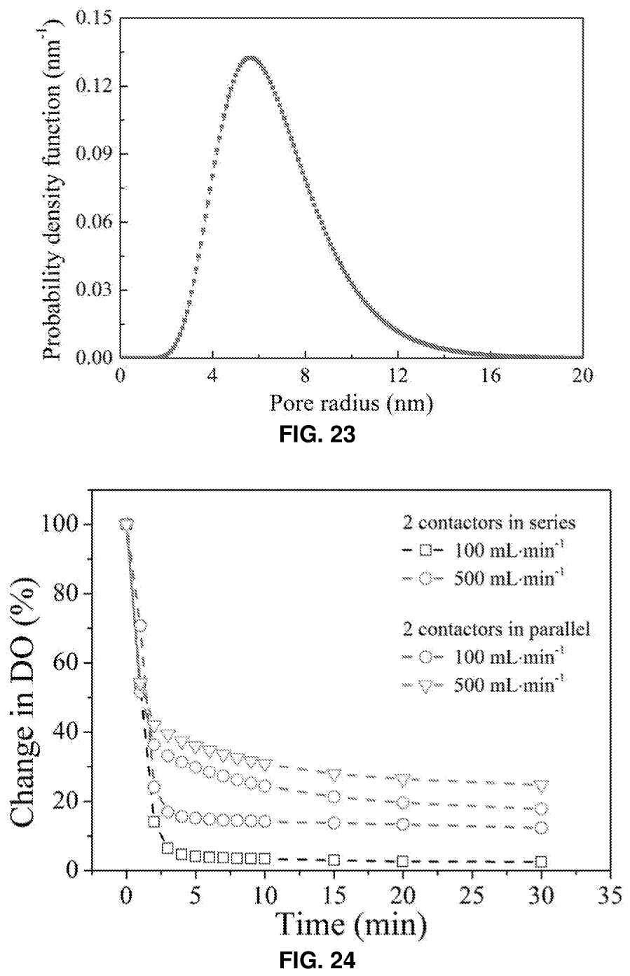

FIG. 23 shows a graph of probability density function (nm⁻¹) vs pore radius (nm). As shown in FIG. 23, pores within the inner skin layer i.e. the inner surface 2222 of FIG. 22 of the tribore hollow fiber membrane are in the range of 2-20 nm with the mean pore radius of 6.3 nm. The membrane comprising the fiber 2200 illustrated in FIG. 22 is in the category of ultrafiltration and the LEP value for water is determined at 9.9 bar.

Performance of Water Deoxygenation

The as-prepared membranes comprising bundles of fibers similar to the fiber 2200 of FIG. 2 were firstly tested for DI water deoxygenation in order to understand the influences of flow rate and operation mode. Performance of water deoxygenation is tested using a setup similar to the set-up 1500 shown in FIG. 15 in which two membrane modules, with each module comprising a bundle of the fibers similar to the fiber 2200 of FIG. 2, are connected in series or parallel. With reference to FIG. 24, the findings are that the DO concentration drastically drops in the first 2 min and the change slows down subsequently. FIG. 24 shows a graph of Change in DO (%) vs Time (min). Under both operation configurations i.e. in series connection or in parallel connection, the water flow rate of 100 mL min⁻¹ generates much faster drop in the DO concentration than the water flow rate at 500 mL min⁻¹. Further increase in the water flow rate above 500 mL min⁻¹ does not significantly influence the DO removal rate as well as the DO concentration in the effluent (data not shown).

Pressure buildup on the lumen side of the membranes of the two membrane modules was observed when the water flow rate was above 700 mL min⁻¹. To avoid the influence of pressure on the transport of oxygen, only results at relatively low flow rates, i.e., 100 and 500 mL min⁻¹, are discussed here. At the same water flow rate, the DO removal rate is faster when the membrane modules are operated in series. Under 100 and 500 mL min⁻¹ water flow rates, the DO removal efficiency is 97.5% and 82.2% when the two membrane modules are operated in series connection and 87.7% and 75.4% when the membrane modules are operated in parallel connection. The experimental mass transfer coefficients are determined as of 2.03×10⁻⁵ and 4.73×10⁻⁵ m s⁻¹ for the series connection and 1.17×10⁻⁵ and 4.01×10⁻⁵ m s⁻¹ for the parallel connection, respectively. The mass transfer coefficient determined for the deoxygenation of DI water is similar to that observed for RO water deoxygenation.

Pristine aquaculture water taken from a recirculating aquaculture system (RAS) was subjected to a deoxygenation test with the two membrane modules (each module comprising a bundle of the fibers similar to the fiber 2200 of FIG. 2) in series connection and under a circulation mode in which the water is recirculated to have more than single-pass through the two membrane modules. As shown in Table 7 below, the aquaculture water is slightly acidic.

TABLE 7
Analysis of aquaculture water

| | | Total suspended | Total dissolved | Turbidity | Chemical oxygen | Nitrate |
|---|---|---|---|---|---|---|
| Test | pH | solids (mg L⁻¹) | solids (mg L⁻¹) | (NTU) | demand (mg L⁻¹) | (mg L⁻¹) |
| Results | 6.4 | 3245 | 800 | 1.39 | 43.0 | 45.5 |

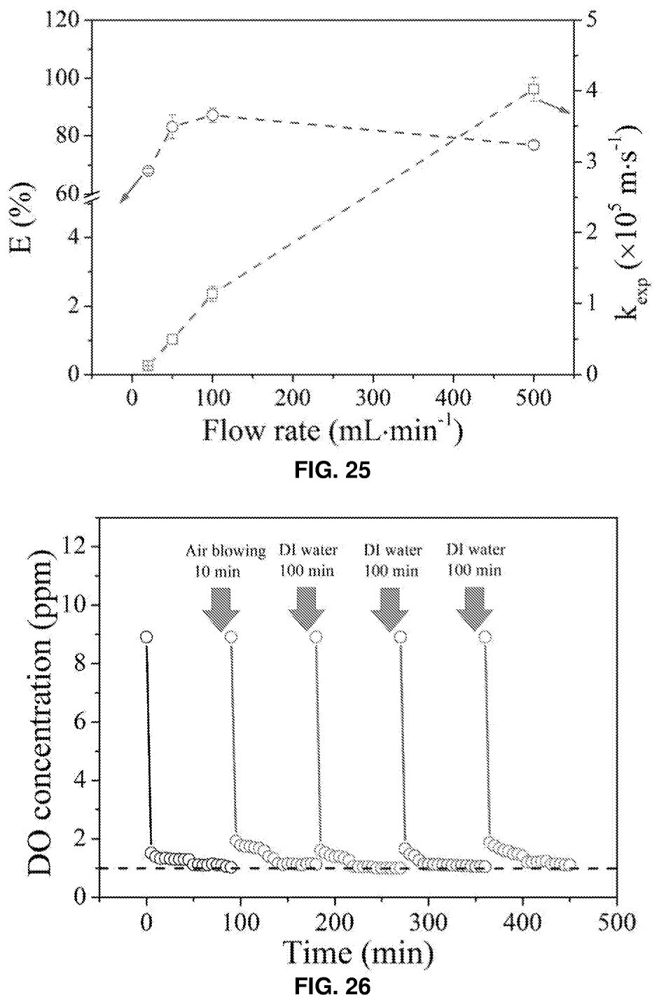

The aquaculture water shows a turbidity of 1.39 NTU and chemical oxygen demand (COD) of 43 mg L⁻¹ and contains 3245 mg L⁻¹ total suspended solids (TSS), 800 mg L⁻¹ total dissolved solids (TDS) and 45.5 mg L⁻¹ nitrate. Under tests conducted under four different water flow rates, the mass transfer coefficient does increase with increase in the water flow rate (FIG. 25). Surprisingly, a flow rate of 100 mL min⁻¹ results in highest DO removal efficiency of 87.3% which is lower than 97.5% observed in the DI water deoxygenation test described earlier. The suspended solids and dissolved organic and biological substances adhered to the membrane inner surface might have fouled the membranes in the membrane modules, reduced the effective membrane area and increased the resistance for oxygen transport. The DO removal efficiency is 68.1% and 83.2% at 20 and 50 mL min⁻¹, respectively. It might be that the flow is too slow and the foulants stay firmly at the membrane inner surface (e.g. Image 2222 of FIG. 22). Though the flow is more vigorous by increasing the water flow rate to 500 mL min⁻¹, the influence from fouling still cannot be apparently mitigated and a DO removal efficiency of 76.8% is achieved. Based on these observations, a water flow rate of 100 mL min⁻¹ was used for the subsequent deoxygenation tests. Air blowing (1.0 bar, 10 min) and DI water flushing (100 min) were firstly applied to clean the membrane modules after deoxygenation of unfiltered aquaculture water due to simplicity to implement deoxygenation of unfiltered aquaculture water in an actual RAS.

As shown in FIG. 26, air blowing is applied after a 1st run of deoxygenation followed by DI water flushing but it does not completely recover the membrane performance as seen from a 2nd run. Flushing with DI water for 100 min does not show better cleaning efficiency than air blowing, and the DO concentration in the effluent slightly increases. For pristine pond water without any pre-treatment, either air blowing or DI water flushing could not effectively remove the foulants deposited at the membrane inner surface (e.g. Image 2222 of FIG. 22) and could not maintain the deoxygenation performance.

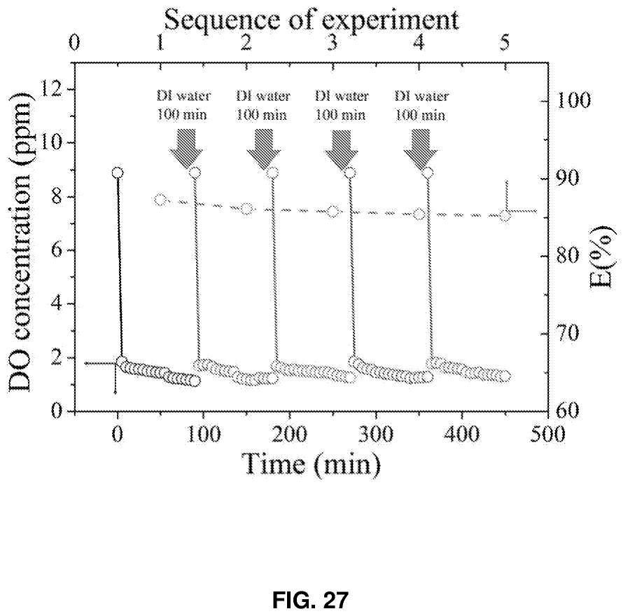

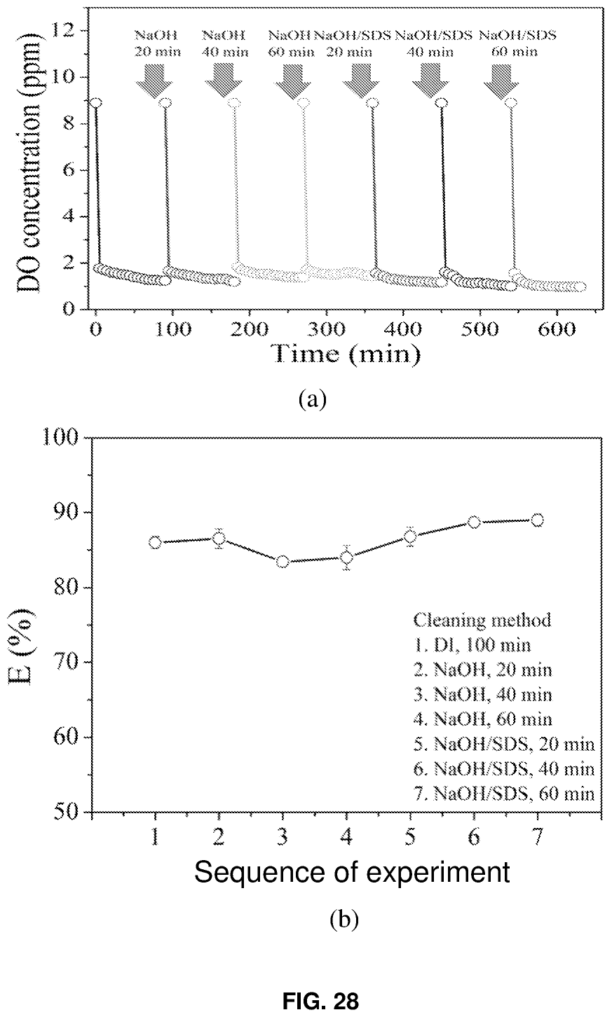

In subsequent experiments, the aquaculture water was filtered to remove the suspended solids before deoxygenation performance evaluation using the same membrane modules. Flushing with DI water is tried firstly and used as a reference. As seen from FIG. 27, the DO level in the effluent still increases gradually after every experiment and the DO removal efficiency slightly drops. It seems that the fouling is not apparently mitigated after the suspended solids are removed. The fouling might have mainly contributed by dissolved organic substances and microorganisms. Cleaning with NaOH solution (pH10) followed by DI water flushing works when the flushing time is increased to 60 min but the efficiency is still quite low (See FIG. 28). FIG. 28 shows two graphs, graph (a) which is a plot of DO concentration (ppm) vs time (min), and graph (b) which is a plot of Oxygen removal efficiency, E (%), vs Sequence of experiments conducted. FIG. 28 illustrates effects of water washing using NaOH or a mixture of NaOH and Sodium Dodecyl Sulfate (SDS) to the oxygen removal performance. A mixture of NaOH (pH10) and SDS (1 mM) is found to be effective to remove the foulants from the membrane surface of the membrane modules. Better recovery of the membrane performance is achieved with lengthening of the cleaning time from 20 to 40 min and 60 min. Furthermore, the cleaning with NaOH/SDS solution could help to maintain the performance of the hollow fiber membranes, i.e. to produce desirable exiting aquaculture water with not higher than 1 ppm DO that is expected for biological denitrification.

Mass Transport of Oxygen: Mass Transfer Coefficient

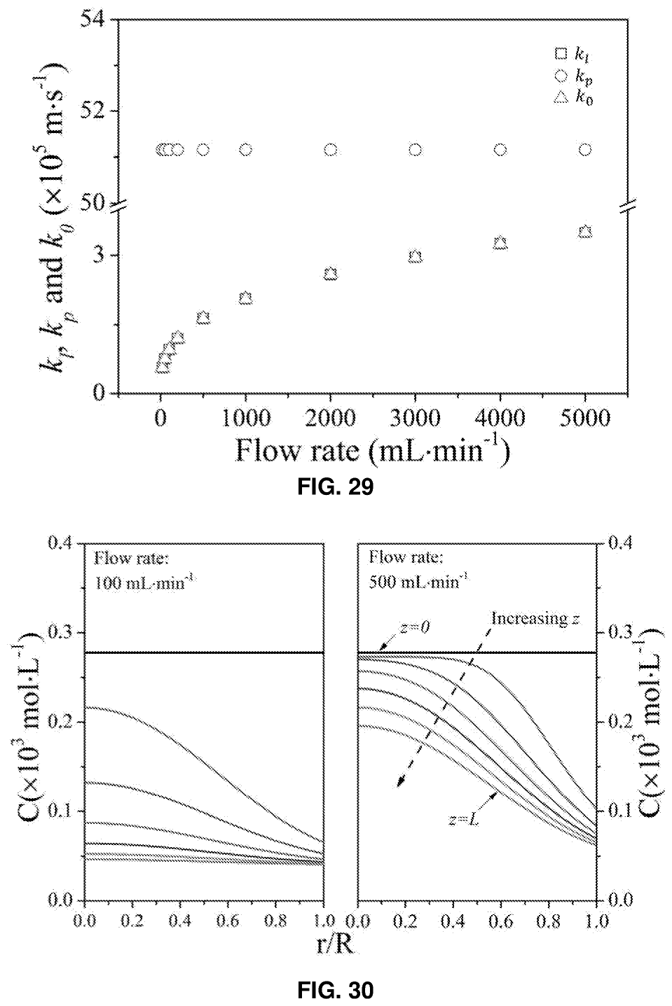

The mass transfer in vacuum deoxygenation involves the diffusion of oxygen in liquid water, membrane pores, and surrounding vacuum or gas stream. Using equations (20), (21) and (22, the mass transfer coefficients in the liquid phase (kₗ) and membrane pore (kₚ) as well as the overall mass transfer coefficient (k₀) are determined and shown in FIG. 29. Equation (21) is essentially the same equation as equation (37), and kₘ of equation (21) and kₚ of equation (37) may be used interchangeably to refer to the mass transfer coefficient in a hydrophobic membrane. FIG. 29 is a graph of kₗ, kₚ and k₀ (×10⁵ m s⁻¹) vs water flow rate (mL min⁻¹). With the objective of understanding the mass transfer, a theoretical study reported here only considers the case that fresh clean water (without foulants) enters the membrane modules (each module comprising a bundle of the fibers similar to the fiber 2200 of FIG. 2) and leaves at an exiting point without circulation (i.e., one-pass mode). Generally, the calculated mass transfer coefficient is in line with the experimental results shown in FIG. 25.

Clearly, the mass transfer coefficient in the membrane pores does not change with increase in the water flow rate and it is much higher than that in the liquid phase. The reason is as follows. The shell side of the fibers in the membrane modules, i.e., the bulk gas phase, is under vacuum. The pores of the membranes in the membrane modules are directly or indirectly connected with the bulk gas phase.

Only gas molecules (e.g., oxygen and water vapor) could enter the pores as a result of the hydrophobic nature of the membrane while they are immediately taken away upon continuous suction in the shell side of the membrane modules. Within the membrane pores, the resistance to the movement of oxygen only comes from the tortuous or interconnected pore walls. The mass transfer coefficient in the liquid water phase (lumen side) is 15-90 times lower than that in the membrane phase. In the lumen side, DO needs to diffuse in water towards the water-gas interface and pass through the interface before entering the membrane pores as gas molecules.

The slow transport of oxygen is directly resulted from low oxygen diffusivity in the bulk water and a boundary layer near the fiber wall of the fibers of the membrane modules. Even at a water flow rate of 1 L min⁻¹, water is still at laminar flow and the influence of mass transfer from the boundary layer is significant. As a result, the overall resistance to the transport of oxygen is dominated by the liquid water phase and the overall mass transfer coefficient (k₀) is determined by the mass transfer coefficient in water (kₗ).

Mass Transport of Oxygen: Concentration Profile

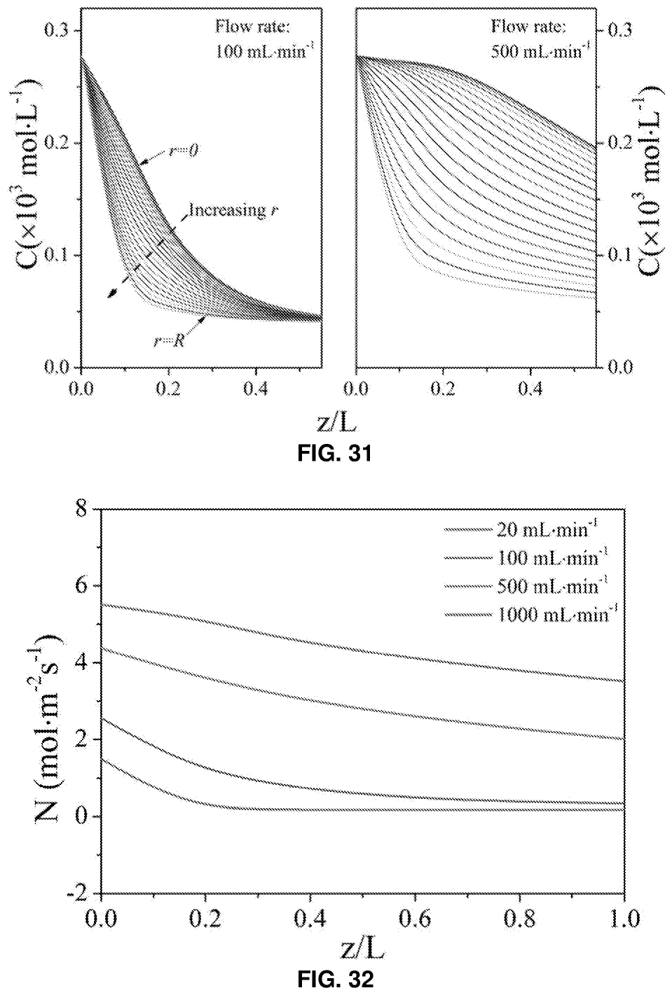

At a water flow rate of 100 mL min⁻¹, the concentration profiles of DO in radial and axial directions relative to the fiber wall of the membrane modules were calculated and are represented in FIG. 30 (radial relative to fiber wall) and FIG. 31 (axial relative to fiber wall), respectively. FIG. 30 is a graph of Concentration, C (×10³ mol L⁻¹), vs r/R (radial relative to fiber wall). FIG. 31 shows a graph of Concentration, C (×10³ mol L⁻¹), vs z/L (axial relative to fiber wall). Showing obviously similar trend with regard to earlier discussion, only radial concentration profiles at water flow rates of 100 and 500 mL min⁻¹ are presented and discussed here. At both water flow rates, the DO concentration at the center of the fiber lumen (r=0) is higher than that at the fiber wall (r=R) while the difference is more significant at a higher water flow rate. At 100 mL min⁻¹ water flow rate, the radial DO concentration varies more significantly near the entrance region of a membrane of one of the membrane modules and the variation becomes less with water flowing through the membrane module. It drops slowly in the later stages. At a half length point (L/2), the DO concentration drops by 68.6% and 83.3% at the center and fiber wall, respectively. Around an exit region of the membrane module, the DO reduction is only 83.2% at the center and 85.3% at the fiber wall. It seems that at low water flow rate the existing DO concentration at the center almost reaches the same level as that at the fiber wall. At 500 mL min⁻¹ water flow rate, the DO removal rate becomes slow as seen from the small change in the radial DO concentration (See FIG. 30). Even though a higher water flow rate means enhanced mass transfer coefficient (See FIG. 29), the significantly shortened residence time within the membrane of the membrane module lowers the ultimate DO removal efficiency.

For the concentration of DO in axial direction for different radial points, the influence of flow rate on the deoxygenation performance is more clearly seen from FIG. 31. At the center of the fiber lumen (r=0), the axial DO concentration falls slowly for 500 mL min⁻¹ water flow rate but falls rapidly at 100 mL min⁻¹ flow rate. Apart from the lumen center, the axial DO concentration at different radial points changes slower at 500 mL min⁻¹ water flow rate. Near the fiber wall, there is a sharp decline in the DO concentration for both cases. The exiting DO concentration corresponding to 500 mL min⁻¹ flow rate has a broad distribution, which is very different from what is seen in another case (See FIG. 31). The possible reason for this phenomenon is that the diffusion of DO from the bulk to the fiber wall where the water-gas interface is located is too slow.

Mass Transport of Oxygen: Molar Flux Profile

The molar flux of DO at different axial positions of the membrane module is shown in FIG. 32. FIG. 32 is a graph of molar flux, N (mol m⁻²s⁻¹), vs z/L (axial relative to fiber wall). Obviously, the molar flux of DO increases with increase in the water flow rate. At low flow rates (e.g., 20 mL min⁻¹), the molar flux is only high in the entrance region (z/L=0.2) and it is almost constant thereafter. For relatively higher water flow rates, the molar flux of DO gradually decreases with water flowing along the membrane module and reaches a minimum value at an exiting point. Calculating from the average DO concentration, the DO removal efficiency is about 85.6%, 84.3%, 52.4% and 35.1% at water flow rates of 20, 100, 500 and 1000 mL min⁻¹, respectively.

Consequently, slow water flow rate is preferred as it results in better deoxygenation performance. It should be noted that these theoretical calculations are based on the assumption that the feed water is clean and there is no membrane fouling. If some foulants exist in the feed water, they tend to deposit on the membrane surface to form an extra layer, which not only reduces the effective membrane surface area for oxygen to transport but also increases the resistance. The fouling is more serious if the flow is slow. For a real scenario, the operation conditions should be optimized by considering the mass transfer rate as well as the membrane fouling propensity simultaneously.

Based on the above studies, in an example of the present disclosure, there may be provided a novel and robust tri-bore hollow fiber membrane developed for water deoxygenation. Its performance is better when at least two of such membranes are connected in series. Based on DI water feed, a DO removal efficiency of 97.5% is achieved at a water flow rate of 100 mL min⁻¹. When applied for aquaculture water, the deoxygenation performance of the at least two membranes slightly decreases and a DO removal efficiency of 87.3% is obtained. Membrane fouling is observed whether the aquaculture water is pre-treated or not. DI water flushing, air blowing or cleaning with NaOH (pH) solution are not thoroughly effective to clean the fouled membranes. A combination of NaOH (OH) and 1 mM SDS shows satisfactory cleaning efficiency and the deoxygenation performance of the membrane could be maintained.

Mathematic modeling has been conducted to investigate the oxygen transportation from water to the gas phase through the membrane. With water flowing in the lumen, the mass transfer coefficient and molar flux of DO increase with increase in the water flow rate. The DO concentrations in radial and axial directions show very different features at low and high water flow rates. However, the ultimate DO removal efficiency would be higher at low water flow rates due to longer residence time, which allows the diffusion of DO from the fiber lumen to the boundary layer and the water-gas interface. The DO removal efficiency could be reduced from 85.6% to 35.1% with increase in the water flow rate from 20 to 1000 mL min⁻¹. For the deoxygenation of relatively clean water without or with minimum foulants, operation of the membrane modules at low flow rate would be preferable.

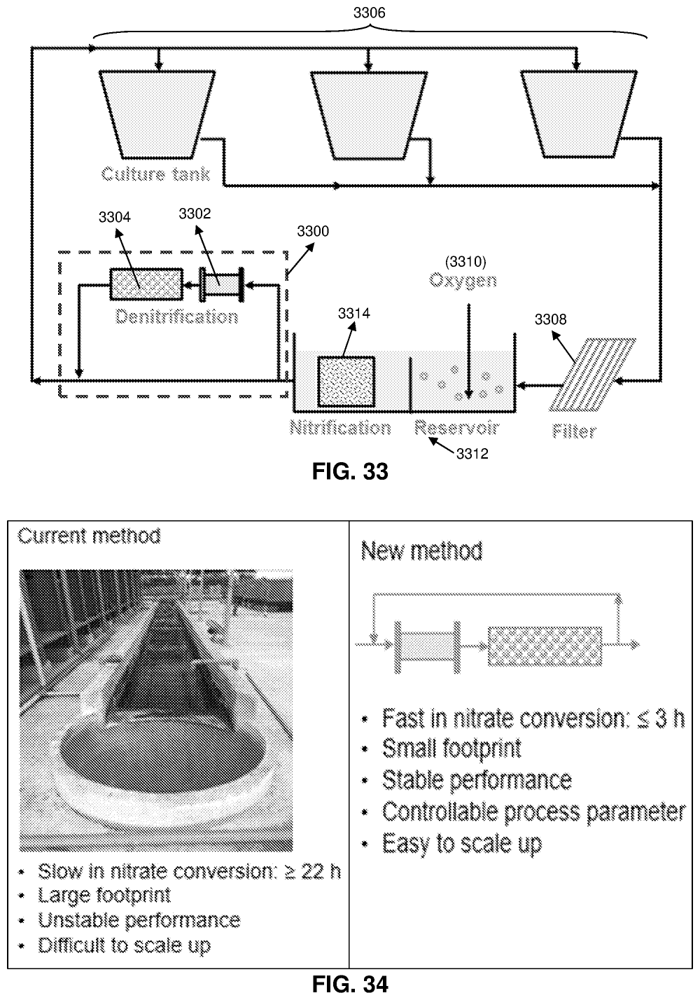

With reference to FIG. 33, another example of the present disclosure relates to the development of a novel denitrification system 3300 (or apparatus) for the removal of nitrate from RAS.

The exemplified system 3300 employs membrane contactor (e.g. each of the membrane modules 1402) and/or nitrogen bubbling to reduce the concentration of dissolved oxygen (DO) and produce culture water that provides an anaerobic environment. The most noteworthy feature of the system 3300 is that no active sludge or commercial bacteria media is involved. The culture water itself includes some biological species, which are used as seeds and directly fed with various nutrients for culturing denitrifying bacteria. The culture water output from the system 3300 is directed to a plurality of culture tanks 3306. The water in the culture tanks 3306 is recirculated. Specifically, the water in the culture tanks 3306 is put through a filter 3308 to remove contaminants. The treated water can be aerated i.e. to infuse oxygen 3310 by pumping into the water at a reservoir 3312, subject to nitrification 3314, subject to denitrification by the system 3300 and sent back to the culturing system i.e. the culture tanks 3306 with zero discharge of wastewater.

Design of New Denitrification System

The newly developed denitrification system 3300 is shown as one portion of a larger system in FIG. 33. The purpose of the larger system that comprises the culture tanks 3306, the filter 3308, the reservoir 3312 and the denitrification system 3300 is to culture denitrifying biological species. The system 3300 comprises of two elements, i.e., membrane contactors 3302 (two or more membrane modules similar to the membrane modules 1402) and bioreactor 3304. The membrane contactors 3302 help to reduce Dissolved Oxygen (DO) while the bioreactor 3304 converts nitrate to nitrogen gas. The membrane contactors can be connected in series or parallel and subject to vacuum like the setup of FIG. 15.

The new method using the newly developed system 3300 is advantageous over the current method (i.e. conventional denitrification system) in terms of much faster nitrate conversion rate, smaller footprint and more stable performance (see FIG. 34). FIG. 34 provides a comparison between the new method and current method. The performance of the new method can be controlled by adjusting the process parameters (such as amount of culturing water, level of DO, etc). Furthermore, it is easier to scale up due to much less dependency on space.

Membrane Contactors for DO Removal

Two pieces of the membrane contactors were fabricated using the novel tri-bore hollow fiber membranes described herein and they are used to remove DO from water. The terms “membrane module” and “membrane contactor” refer to the same object in the present disclosure and are used interchangeably. FIG. 14 shows an example of the membrane contactor (i.e. one of the membrane modules 1402), the cross section of the membrane contactor and the cross section of a tri-bore hollow fiber in a bundle of such fibers in the membrane contactor. In the experiments described earlier with reference to the two membrane modules 1402, these two membrane contactors 1402 were connected in series with aquaculture water (see Table 7) flowing at a lumen side of the membranes of the membrane contactors 1402 and vacuum applied on a shell side of the membranes of the membrane contactors 1402.

As shown in FIG. 28(a), the DO level in aquaculture water could be reduced to 1 ppm, which is considered as suitable for biological denitrification. Membrane fouling occurs after running several cycles while cleaning with a mixture of sodium hydroxide and sodium dodeyl sulfate (NaOH/SDS), which is effective to remove foulants from the membranes and recover their performance. An alternative to the use of the membrane contactors 1402 is nitrogen bubbling, which is not the focus of the present disclosure.

Culturing of Biological Species for Denitrification

The culturing of biological species in aquaculture water relies on the concentration of nitrate and carbon source. The carbon source (e.g. ethanol) and nutrient (KNO₃) are fed to the bioreactor 3304 containing 6 L aquaculture water at a specific ratio. When nitrate is digested to below 20 ppm, more KNO₃ nutrient is added to the reactor. After the concentration of nitrate decreases to below 20 ppm again, the biological species are ready for denitrification experiments. The above experiments are repeatable, proving that feeding nitrate and ethanol directly to the aquaculture water is an efficient and easy way to prepare the denitrifying biological species.

The Effect of Different Carbon Sources

To study the effect of carbon source on denitrification efficiency, three types of commonly used carbon sources including methanol, ethanol and sodium acetate have been studied. For each trial, 4 liters of cultured aquaculture water (containing anaerobic biological species) is mixed with 2 liters of tap water (after deoxygenation). KNO₃ is added into the mixture to reach a nitrate concentration of 100 ppm while the carbon source is added subsequently. The mixture is continuously stirred and the concentration of nitrate is monitored.

It can be seen from Table 9 below that methanol is obviously the best carbon source with 99% nitrate converted within 2 hours 40 minutes. Sodium acetate as the carbon source could also achieve 99% nitrate conversion within 3 hours. Its efficiency is not as good as that achieved by methanol but is better than that of ethanol. Nevertheless, ethanol as the carbon source can still achieve 99% nitrate conversion within 3.5 hours (data not included in Table 8) and is also applicable for denitrification process.

TABLE 8
Effect of different carbon source on the denitrification of nitrate

| Time (hour) | | 0 | 1 | 2 | 2.33 | 2.50 | 2.67 | 3 |
|---|---|---|---|---|---|---|---|---|
| NO₃⁻ (ppm) | Ethanol | 100 | >250 | >250 | | 208 | | 78 |
| | Methanol | 100 | >250 | >250 | 83 | 20 | 1 | |
| | Sodium Acetate | 100 | >250 | >250 | | 124 | 70.5 | 1 |

The Effect of DO Level on Denitrification

Tests were conducted in parallel to study the effect of DO level on denitrification. Two water samples were prepared by mixing 4 liters of pond water containing cultured biological species and 2 liters of tap water. The concentration of nitrate was adjusted by adding certain amount of potassium nitrate while methanol was added as the carbon source. One water sample (S1) was purged with nitrogen for more than one hour to reduce the DO level to below 0.1 ppm. Another water sample (S2) was slightly aerated using an air pump to achieve the DO level of 1.0 ppm.

As shown in Table 9, DO level in the water sample does have significant influence on the rate of denitrification and final conversion of nitrate. For the water sample with the initial DO level below 0.1 ppm (S1), the nitrate conversion of 99% is achieved within 2 hours 10 minutes. Comparatively, for the water sample with 1 ppm initial DO (S2), the rate of denitrification is relatively slow. It takes 3 hours 20 minutes to achieve the same nitrate conversion seen in S2. Once again, an increase in the concentration of nitrate in the beginning of the test is observed in both water samples. S2 shows more significant increase in nitrate concentration. It might be that nitrification of the pond water is far from complete. With more DO in the water sample, the aerobic species are still active and they can convert the remaining nitrogen-containing substances into nitrite and then nitrate.

TABLE 9
Effect of DO level on denitrification

| Time | 0 | 1 | 2 | 2.17 | 3 | 3.17 | 3.33 |
|---|---|---|---|---|---|---|---|
| NO₃⁻ (ppm) in S1 | 100 | 172 | 11 | 1 | — | — | — |
| NO₃⁻ (ppm) in S2 | 100 | 173 | >250 | 276 | 72 | 27 | 1 |

In conventional RAS system where nitrifying biofilters are used for converting ammonia to nitrate, nitrate reaches high concentrations and would affect the growth of aquatic species. Examples of the present disclosure include an innovative membrane-assisted denitrification system (e.g. 3300). By controlling the level of dissolved oxygen, the exemplified system proposed in the present disclosure is able to significantly enhance the controllability of denitrification reaction and accelerate the removal of nitrate from the culturing water.

In a further example of the present disclosure, a membrane-assisted bioreactor is used to control the nitrate concentration in RAS. The control method used in the present example of the system 3300 includes two main components as shown below.
1) One or more membrane contactor (3302 of FIG. 33)
   a) A membrane contactor containing PVDF hollow fiber membranes is used to reduce DO to 1 ppm or a lower concentration in aquaculture water
   b) The membranes should be hydrophobic, i.e., allowing gases instead of liquid water to pass through.
   c) Hydrophobic membranes made from other PP, PTFE, PC or other materials could be also used for DO control
2) One Bioreactor (3304 of FIG. 33)
   a) The bioreactor contains biological species specially cultured.
   b) The biological species are cultured using water taken from RAS.
   c) The biological species are cultured under anaerobic environment created by 1) (i.e. the one or more membrane contactor) above.

Bioreactor-like facilities are being used in some local fish farms. The reactor is simple and large without any control of the operation conditions. Therefore, the efficiency of denitrification is very low. With reference to FIG. 34, the present example is superior to existing devices in the following aspects:
(a) Fast in nitrate conversion: less than or equal than 3 hours
(b) Small footprint
(c) Stable performance
(d) Controllable process parameter

(e) Easy to scale up

In comparison with a conventional method, the conventional method has the following disadvantages:
1) Slow in nitrate conversion: greater than or equal to 22 hours
2) Large footprint
3) Unstable performance
4) Difficulty to scale up

Besides nitrate control in RAS, the proposed system (e.g. 3300 of FIG. 33) in the present disclosure can be also used for
(i) removal of nitrate from sewage;
(ii) removal of nitrate from municipal wastewater; and
(iii) removal of nitrate from ground water.

Examples of the present disclosure may have the following features.

A hollow fiber membrane for removal of dissolved oxygen from fluid, wherein the hollow fiber membrane comprises:
at least one tubular fiber, wherein each tubular fiber comprises:
   an outer wall for contacting fluid external to the tubular fiber;
   at least three inner channel walls for contacting fluid internal of the tubular fiber, wherein each inner channel wall forms a fluid communicating channel; and
   a plurality of pores, wherein
      pores proximate to surface of the outer wall for contacting fluid, and
      pores proximate to surface of each inner channel wall for contacting fluid, are smaller in size than
      pores located at locations within the outer wall that are non-proximate to the surface of the outer wall for contacting fluid, and
      pores located at locations within the inner channel walls that are non-proximate to the surface of each inner channel wall for contacting fluid,
wherein the hollow fiber membrane is a porous hydrophobic material configured to prevent water from entering the plurality of pores but to allow gas to enter the plurality of pores,
wherein a central portion of each tubular fiber surrounded by the fluid communicating channels formed by each inner channel wall has a thickness greater than
a thickness of the tubular fiber between the outer wall and each inner channel wall, and
a thickness of the tubular fiber between the at least three inner channel walls.

The tubular fiber may comprise exactly three inner channel walls.

The porous hydrophobic material may be polycarbonate, polypropylene, polyvinylidene fluoride and/or polytetrafluoroethylene.

The porous hydrophobic material may be only polyvinylidene fluoride.

The inner diameter of each fluid communicating channel may be about 670 μm and outer diameter of the tubular fiber may be about 1600 μm.

Cross-section of the hollow fiber membrane may comprise the three fluid communicating channels spaced apart in a configuration that results in the outer walls of the tubular fiber forming a triangular shape.

Porosity of the porous hydrophobic material may be about 75%.

Porous hydrophobic material may have a water contact angle of about 94°.

Sizes of the pores proximate to surface of the outer wall for contacting fluid and the pores proximate to surface of each inner channel wall for contacting fluid may be in a range of about 2 nm to 20 nm, with a mean pore radius of about 6.3 nm.

Liquid entry pressure value for water of the porous hydrophobic material may be about 9.9 bar.

The hollow fiber membrane may be made by a dry-jet wet phase inversion spinning process using an air gap of about 15 cm.

A membrane contactor for removal of dissolved oxygen from fluid, the membrane contactor comprising:
a casing; and
the hollow fiber membrane,
wherein at least one end of the hollow fiber membrane is bonded in the casing through an epoxy resin.

An apparatus for controlling nitrate concentration level in water contained in a recirculating aquaculture system, the apparatus comprising:
the membrane contactor to contact water in a recirculating aquaculture system to filter out gas in the water;
an air pump to create a vacuum in the casing of the membrane contactor to remove all or substantially all gas filtered out from the water contacting the membrane contactor so that the water contains low level of dissolved oxygen; and
a denitrifying culture tank comprising biological species cultured using the water containing low level of dissolved oxygen.

A fluid-soluble carbon source and/or nitrate may be added to the water containing low level of dissolved oxygen for culturing the biological species.

The apparatus may comprise at least two of the membrane contactor connected in series.

A method for controlling nitrate concentration level in water contained in a recirculating aquaculture system, the method comprising:
contacting water in a recirculating aquaculture system with the membrane contactor to filter out gas in the water;
creating a vacuum in the casing of the membrane contactor to remove all or substantially all gas filtered out from the water contacting the membrane contactor so that the water contains low level of dissolved oxygen; and
channeling the water containing low level of dissolved oxygen to a denitrifying culture tank comprising biological species to be cultured.

The method may comprise:
cleaning the water in the recirculating aquaculture system using a mixture of NaOH and Sodium Dodecyl Sulfate (SDS) before contacting the water with the membrane contactor.

In the specification and claims, unless the context clearly indicates otherwise, the term “comprising” has the non-exclusive meaning of the word, in the sense of “including at least” rather than the exclusive meaning in the sense of “consisting only of”. The same applies with corresponding grammatical changes to other forms of the word such as “comprise”, “comprises” and so on.

While the invention has been described in the present disclosure in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A hollow fiber membrane for removal of dissolved oxygen from fluid, wherein the hollow fiber membrane comprises:
at least one tubular fiber, wherein each tubular fiber comprises:
an outer wall for contacting fluid external to the tubular fiber;
at least three inner channel walls for contacting fluid internal of the tubular fiber, wherein each inner channel wall forms a fluid communicating channel; and
a plurality of pores, wherein
pores proximate to surface of the outer wall for contacting fluid, and
pores proximate to surface of each inner channel wall for contacting fluid,
are smaller in size than
pores located at locations within the outer wall that are non-proximate to the surface of the outer wall for contacting fluid, and
pores located at locations within the inner channel walls that are non-proximate to the surface of each inner channel wall for contacting fluid,
wherein the hollow fiber membrane is a porous hydrophobic material configured to prevent water from entering the plurality of pores but to allow gas to enter the plurality of pores,
wherein a central portion of each tubular fiber surrounded by the fluid communicating channels formed by each inner channel wall has a thickness greater than
a thickness of the tubular fiber between the outer wall and each inner channel wall, and
a thickness of the tubular fiber between the at least three inner channel walls.

2. The hollow fiber membrane according to claim 1, wherein there are exactly three inner channel walls.

3. The hollow fiber membrane according to claim 1, wherein the porous hydrophobic material is polycarbonate, polypropylene, polyvinylidene fluoride and/or polytetrafluoroethylene.

4. The hollow fiber membrane according to claim 3, wherein the porous hydrophobic material is only polyvinylidene fluoride.

5. The hollow fiber membrane according to claim 1, wherein the inner diameter of each fluid communicating channel is about 670 μm and outer diameter of the tubular fiber is about 1600 μm.

6. The hollow fiber membrane according to claim 5, wherein cross-section of the hollow fiber membrane comprises the three fluid communicating channels spaced apart in a configuration that results in the outer walls of the tubular fiber forming a triangular shape.

7. The hollow fiber membrane according to claim 1, wherein porosity of the porous hydrophobic material is about 75%.

8. The hollow fiber membrane according to claim 1, wherein the porous hydrophobic material has a water contact angle of about 94°.

9. The hollow fiber membrane according to claim 1, wherein sizes of
the pores proximate to surface of the outer wall for contacting fluid, and
the pores proximate to surface of each inner channel wall for contacting fluid are in a range of about 2 nm to 20 nm, with a mean pore radius of about 6.3 nm.

10. The hollow fiber membrane according to claim 1, wherein liquid entry pressure value for water of the porous hydrophobic material is about 9.9 bar.

11. The hollow fiber membrane according to claim 1, wherein the hollow fiber membrane is made by a dry-jet wet phase inversion spinning process using an air gap of about 15 cm.

12. A membrane contactor for removal of dissolved oxygen from fluid,
the membrane contactor comprising:
a casing; and
the hollow fiber membrane according to claim 1, wherein at least one end of the hollow fiber membrane is bonded in the casing through an epoxy resin.

13. An apparatus for controlling nitrate concentration level in water contained in a recirculating aquaculture system, the apparatus comprising:
the membrane contactor according to claim 12 to contact water in a recirculating aquaculture system to filter out gas in the water;
an air pump to create a vacuum in the casing of the membrane contactor to remove all or substantially all gas filtered out from the water contacting the membrane contactor so that the water contains low level of dissolved oxygen; and
a denitrifying culture tank comprising biological species cultured using the water containing low level of dissolved oxygen.

14. The apparatus according to claim 13, wherein a fluid-soluble carbon source and/or nitrate is added to the water containing low level of dissolved oxygen for culturing the biological species.

15. The apparatus according to claim 13, wherein the apparatus comprises at least two of the membrane contactor connected in series.

16. A method for controlling nitrate concentration level in water contained in a recirculating aquaculture system, the method comprising:
contacting water in a recirculating aquaculture system with the membrane contactor according to claim 12 to filter out gas in the water;
creating a vacuum in the casing of the membrane contactor to remove all or substantially all gas filtered out from the water contacting the membrane contactor so that the water contains low level of dissolved oxygen; and
channeling the water containing low level of dissolved oxygen to a denitrifying culture tank comprising biological species to be cultured.

17. The method according to claim 16, the method comprising:
cleaning fouled membranes in the recirculating aquaculture system using a mixture of NaOH and Sodium Dodecyl Sulfate (SDS).
